(19) United States
(12) Patent Application Publication
(10) Pub. No.: US 2025/0279918 A1
(43) Pub. Date: Sep. 4, 2025

(54) ENHANCED LONG RANGE PHYSICAL LAYER PROTOCOL DATA UNIT DESIGN AND NUMEROLOGY

(71) Applicant: QUALCOMM Incorporated, San Diego, CA (US)

(72) Inventors: Lin YANG, San Diego, CA (US); Bin TIAN, San Diego, CA (US); Tzu-Hsuan CHOU, San Diego, CA (US); Youhan KIM, Saratoga, CA (US); Didier Johannes Richard VAN NEE, Tull en 't Waal (NL); Chin-Hung CHEN, Milpitas, CA (US)

(21) Appl. No.: 18/796,577

(22) Filed: Aug. 7, 2024

Related U.S. Application Data
(60) Provisional application No. 63/559,756, filed on Feb. 29, 2024.

(51) Int. Cl. H04L 27/26; H04L 1/00

(52) U.S. Cl. CPC H04L 27/2603; H04L 1/0003; H04L 1/0061; H04L 1/0071; H04L 27/2613

(57) ABSTRACT

This disclosure provides methods, components, devices and systems for enhanced long range physical layer protocol data unit design and numerology. Some aspects more specifically relate to enhanced long range physical layer protocol data unit design and numerology. A first wireless device may transmit a first portion of a preamble of a PPDU and a second portion of a preamble including at least a first ELR mark field, a second ELR mark field, and an ELR modulated portion. The first ELR mark field and the second ELR mark field both may be modulated according to a quadrature-binary phase-shift keying modulation scheme. The first wireless device may modulate a portion of the PPDU, including at least an ELR signaling field and an ELR data field, according to a modulation scheme selected based on a target data rate and associated with a duplication procedure for the portion of the PPDU.

### CROSS REFERENCE

The present application for patent claims the benefit of U.S. Provisional Patent Application No. 63/559,756 by YANG et al., entitled “ENHANCED LONG RANGE PHYSICAL LAYER PROTOCOL DATA UNIT DESIGN AND NUMEROLOGY,” filed Feb. 29, 2024, assigned to the assignee hereof, and expressly incorporated by reference herein.

### TECHNICAL FIELD

This disclosure relates generally to wireless communication and, more specifically, to enhanced long range physical layer protocol data unit design and numerology.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some wireless networks, one or more wireless devices may communicate over a coverage region that is extended relative to other communications. Such communications may be referred to as enhanced long range (ELR) communications.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless device. The method may include transmitting a first portion of a preamble of a physical layer protocol data unit (PPDU), the first portion of the preamble including at least a legacy short training field, a legacy long training field, a legacy signal field, and a repeat legacy signal field and transmitting a second portion of the preamble, the second portion of the preamble including at least a first enhanced long range (ELR) mark field, a second ELR mark field, and an ELR modulated portion, the first ELR mark field and the second ELR mark field both modulated according to a quadrature-binary phase-shift keying (QBPSK) modulation scheme.

Another innovative aspect of the subject matter described in this disclosure can be implemented in a first wireless device for wireless communications. The first wireless device may include a processing system that includes processor circuitry and memory circuitry that stores code. The processing system may be configured to cause the first wireless device to transmit a first portion of a preamble of a PPDU, the first portion of the preamble including at least a legacy short training field, a legacy long training field, a legacy signal field, and a repeat legacy signal field and transmit a second portion of the preamble, the second portion of the preamble including at least a first ELR mark field, a second ELR mark field, and an ELR modulated portion, the first ELR mark field and the second ELR mark field both modulated according to a QBPSK modulation scheme.

Another innovative aspect of the subject matter described in this disclosure can be implemented in another first wireless device for wireless communications. The first wireless device may include means for transmitting a first portion of a preamble of a PPDU, the first portion of the preamble including at least a legacy short training field, a legacy long training field, a legacy signal field, and a repeat legacy signal field and means for transmitting a second portion of the preamble, the second portion of the preamble including at least a first ELR mark field, a second ELR mark field, and an ELR modulated portion, the first ELR mark field and the second ELR mark field both modulated according to a QBPSK modulation scheme.

Another innovative aspect of the subject matter described in this disclosure can be implemented in a non-transitory computer-readable medium storing code for wireless communications. The code may include instructions executable by one or more processors to transmit a first portion of a preamble of a PPDU, the first portion of the preamble including at least a legacy short training field, a legacy long training field, a legacy signal field, and a repeat legacy signal field and transmit a second portion of the preamble, the second portion of the preamble including at least a first ELR mark field, a second ELR mark field, and an ELR modulated portion, the first ELR mark field and the second ELR mark field both modulated according to a QBPSK modulation scheme.

In some examples of the method, first wireless devices, and non-transitory computer-readable medium described herein, transmitting the second portion of the preamble may include operations, features, means, or instructions for transmitting the second portion of the preamble that includes an ELR signaling field and an ELR data field.

In some examples of the method, first wireless devices, and non-transitory computer-readable medium described herein, transmitting the second portion of the preamble may include operations, features, means, or instructions for transmitting the second portion of the preamble that includes an ELR short training field and an ELR long training field.

A method for wireless communications by a second wireless device is described. The method may include receiving a first portion of a preamble of a PPDU, the first portion of the preamble including at least a legacy short training field, a legacy long training field, a legacy signal field, and a repeat legacy signal field and receiving a second portion of the preamble, the second portion of the preamble including at least a first ELR mark field, a second ELR mark field, and an ELR modulated portion, the first ELR mark field and the second ELR mark field both modulated according to a QBPSK modulation scheme.

Another innovative aspect of the subject matter described in this disclosure can be implemented in a second wireless device for wireless communications. The second wireless device may include a processing system that includes processor circuitry and memory circuitry that stores code. The processing system may be configured to cause the second wireless device to receive a first portion of a preamble of a PPDU, the first portion of the preamble including at least a legacy short training field, a legacy long training field, a legacy signal field, and a repeat legacy signal field and receive a second portion of the preamble, the second portion of the preamble including at least a first ELR mark field, a second ELR mark field, and an ELR modulated portion, the first ELR mark field and the second ELR mark field both modulated according to a QBPSK modulation scheme.

Another innovative aspect of the subject matter described in this disclosure can be implemented in another second wireless device for wireless communications. The second wireless device may include means for receiving a first portion of a preamble of a PPDU, the first portion of the preamble including at least a legacy short training field, a legacy long training field, a legacy signal field, and a repeat legacy signal field and means for receiving a second portion of the preamble, the second portion of the preamble including at least a first ELR mark field, a second ELR mark field, and an ELR modulated portion, the first ELR mark field and the second ELR mark field both modulated according to a QBPSK modulation scheme.

Another innovative aspect of the subject matter described in this disclosure can be implemented in a non-transitory computer-readable medium storing code for wireless communications. The code may include instructions executable by one or more processors to receive a first portion of a preamble of a PPDU, the first portion of the preamble including at least a legacy short training field, a legacy long training field, a legacy signal field, and a repeat legacy signal field and receive a second portion of the preamble, the second portion of the preamble including at least a first ELR mark field, a second ELR mark field, and an ELR modulated portion, the first ELR mark field and the second ELR mark field both modulated according to a QBPSK modulation scheme.

In some examples of the method, second wireless devices, and non-transitory computer-readable medium described herein, receiving the second portion of the preamble may include operations, features, means, or instructions for receiving the second portion of the preamble that includes an ELR signaling field and an ELR data field.

In some examples of the method, second wireless devices, and non-transitory computer-readable medium described herein, receiving the second portion of the preamble may include operations, features, means, or instructions for receiving the second portion of the preamble that includes an ELR short training field and an ELR long training field.

Another innovative aspect of the subject matter described in this disclosure can be implemented in a method for wireless communications by a first wireless device. The method may include modulating a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and transmitting the portion of the PPDU in accordance with the modulation scheme.

Another innovative aspect of the subject matter described in this disclosure can be implemented in a first wireless device for wireless communications. The first wireless device may include a processing system that includes processor circuitry and memory circuitry that stores code. The processing system may be configured to cause the first wireless device to modulate a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and transmit the portion of the PPDU in accordance with the modulation scheme.

Another innovative aspect of the subject matter described in this disclosure can be implemented in another first wireless device for wireless communications. The first wireless device may include means for modulating a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and means for transmitting the portion of the PPDU in accordance with the modulation scheme.

Another innovative aspect of the subject matter described in this disclosure can be implemented in a non-transitory computer-readable medium storing code for wireless communications. The code may include instructions executable by one or more processors to modulate a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and transmit the portion of the PPDU in accordance with the modulation scheme.

In some examples of the method, first wireless devices, and non-transitory computer-readable medium described herein, modulating the portion of the PPDU may include operations, features, means, or instructions for modulating the portion of the PPDU according to the modulation scheme in accordance with a time domain duplication procedure, where each repetition of a set of repetitions corresponding to the portion of the PPDU may be associated with a respective guard interval or a same guard interval.

In some examples of the method, first wireless devices, and non-transitory computer-readable medium described herein, modulating the portion of the PPDU may include operations, features, means, or instructions for modulating the portion of the PPDU according to the modulation scheme in accordance with a time domain duplication procedure, where each block of a set of blocks corresponding to the portion of the PPDU may be associated with a respective guard interval, and where each repetition of a set of repetitions within each block may be associated with a same guard interval.

In some examples of the method, first wireless devices, and non-transitory computer-readable medium described herein, modulating the portion of the PPDU may include operations, features, means, or instructions for modulating the portion of the PPDU according to the modulation scheme in accordance with a coded-bits duplication procedure that includes a repetition of one or more blocks before an interleaving procedure.

In some examples of the method, first wireless devices, and non-transitory computer-readable medium described herein, modulating the portion of the PPDU may include operations, features, means, or instructions for modulating the portion of the PPDU according to the modulation scheme in accordance with a frequency domain duplication procedure.

In some examples of the method, first wireless devices, and non-transitory computer-readable medium described herein, modulating the portion of the PPDU may include operations, features, means, or instructions for modulating the portion of the PPDU according to the modulation scheme in accordance with a distributed tone resource unit procedure.

A method for wireless communications by a second wireless device is described. The method may include receiving a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and decoding the portion of the PPDU to obtain one or more bits of the ELR signaling field, the ELR data field, or both.

A second wireless device for wireless communications is described. The second wireless device may include a processing system that includes processor circuitry and memory circuitry that stores code. The processing system may be configured to cause the second wireless device to receive a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and decode the portion of the PPDU to obtain one or more bits of the ELR signaling field, the ELR data field, or both.

Another second wireless device for wireless communications is described. The second wireless device may include means for receiving a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and means for decoding the portion of the PPDU to obtain one or more bits of the ELR signaling field, the ELR data field, or both.

A non-transitory computer-readable medium storing code for wireless communications is described. The code may include instructions executable by one or more processors to receive a portion of a PPDU according to a modulation scheme of a set of modulation schemes, the portion of the PPDU including at least an ELR signaling field and an ELR data field, where the modulation scheme is selected based on a target data rate and is associated with a duplication procedure for the portion of the PPDU and decode the portion of the PPDU to obtain one or more bits of the ELR signaling field, the ELR data field, or both.

In some examples of the method, second wireless devices, and non-transitory computer-readable medium described herein, receiving the portion of the PPDU may include operations, features, means, or instructions for receiving the portion of the PPDU according to the modulation scheme in accordance with a time domain duplication procedure, where each repetition of a set of repetitions corresponding to the portion of the PPDU may be associated with a respective guard interval or a same guard interval.

In some examples of the method, second wireless devices, and non-transitory computer-readable medium described herein, modulating the portion of the PPDU may include operations, features, means, or instructions for modulating the portion of the PPDU according to the modulation scheme in accordance with a time domain duplication procedure, where each block of a set of blocks corresponding to the portion of the PPDU may be associated with a respective guard interval, and where each repetition of a set of repetitions within each block may be associated with a same guard interval.

In some examples of the method, second wireless devices, and non-transitory computer-readable medium described herein, receiving the portion of the PPDU may include operations, features, means, or instructions for receiving the portion of the PPDU according to the modulation scheme in accordance with a coded-bits duplication procedure that includes a repetition of one or more blocks before an interleaving procedure.

In some examples of the method, second wireless devices, and non-transitory computer-readable medium described herein, receiving the portion of the PPDU may include operations, features, means, or instructions for receiving the portion of the PPDU according to the modulation scheme in accordance with a frequency domain duplication procedure.

In some examples of the method, second wireless devices, and non-transitory computer-readable medium described herein, receiving the portion of the PPDU may include operations, features, means, or instructions for receiving the portion of the PPDU according to the modulation scheme in accordance with a distributed tone resource unit procedure.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows an example of a signaling diagram that supports enhanced long range physical layer protocol data unit design and numerology.

FIG. 7 shows an example of a process flow that supports enhanced long range physical layer protocol data unit design and numerology.

FIG. 8 shows an example of a process flow that supports enhanced long range physical layer protocol data unit design and numerology.

FIG. 9 shows a block diagram of an example wireless communication device that supports enhanced long range physical layer protocol data unit design and numerology.

FIG. 10 shows a flowchart illustrating an example process performable by or at a first wireless device that supports enhanced long range physical layer protocol data unit design and numerology.

FIG. 11 shows a flowchart illustrating an example process performable by or at a second wireless device that supports enhanced long range physical layer protocol data unit design and numerology.

FIG. 12 shows a flowchart illustrating an example process performable by or at a first wireless device that supports enhanced long range physical layer protocol data unit design and numerology.

FIG. 13 shows a flowchart illustrating an example process performable by or at a second wireless device that supports enhanced long range physical layer protocol data unit design and numerology.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to enhanced long range (ELR) physical layer protocol data unit (PPDU) design and numerology. In some implementations, one or more wireless devices, such as wireless stations (STAs), wireless access points (APs), or both in a WLAN communications system, may extend a distance, or coverage range, over which wireless communications are provided. For example, a first wireless device may communicate with a second wireless device over a distance that is extended relative to other WLAN communication systems. To facilitate such ELR communications, the wireless devices may utilize a PPDU that is designed to obtain a target data rate over the extended coverage range. Accordingly, a first wireless device may transmit the PPDU, formatted and configured according to ELR communications, to a second wireless device, such that the second wireless device may detect and decode the packet. In such examples, the second wireless device may attempt to identify whether the packet is associated with (or intended for) ELR communications, for example, by performing one or more parallel hypothesis tests. However, performance of one or more parallel hypothesis tests may increase the complexity of packet detection at the second wireless device. Such complexity may lead to an increase in lost or misinterpreted PPDUs during ELR communications, thereby increasing latency in the ELR communications and increasing power consumption at the one or more wireless devices.

As described herein, systems and techniques may implement a PPDU design that enables the second wireless device to detect a PPDU relatively quickly, while reducing the complexity of parallel hypothesis tests. For example, a first wireless device may prepare a PPDU for transmission using one or more modulation schemes and one or more duplication procedures. In some implementations, the first wireless device may transmit a first portion of a preamble of a PPDU. The first portion of the preamble may include at least a legacy short training field, a legacy long training field, a legacy signal field, and a repeat legacy signal field. The first wireless device may transmit a second portion of the preamble. The second portion of the preamble may include at least a first ELR mark field, a second ELR mark field, and an ELR modulated portion. The first ELR mark field and the second ELR mark field may both be modulated according to a quadrature-binary phase-shift keying (QBPSK) modulation scheme.

Additionally, or alternatively, the first wireless device may modulate a portion of a PPDU according to a modulation scheme of a set of modulation schemes. The portion of the PPDU may include at least an ELR signaling field and an ELR data field. The first wireless device may select the modulation scheme based on a target data rate. The modulation scheme may be associated with a duplication procedure for the portion of the PPDU. The duplication procedure may be a time-domain duplication procedure, a frequency domain duplication procedure, a coded-bits duplication procedure, a distributed tone transmission procedure, or a similar procedure.

Particular aspects of the subject matter described in this disclosure can be implemented to realize one or more of the following potential advantages. In some implementations, by including the first and second ELR mark fields and the ELR signaling field immediately following in the second portion of the PPDU, the described techniques can be used by the second wireless device to decode PPDUs which are relevant for the second wireless device and may refrain from decoding entire PPDUs which are not relevant or usable by the second wireless device. This may reduce latency and power consumption at the second wireless device. Additionally, by modulating the portion of the PPDU according to the modulation scheme associated with the duplication procedure, the first wireless device may transmit the ELR signaling and data fields with relatively low date rate and an increase in power boosting on the preamble of the PPDU, thereby increasing the reliability of reception at the second wireless device. This increased reliability of reception may improve coverage and user experience with respect to the wireless communications, resulting in increased throughput and spectral efficiency. Accordingly, ELR signature fields with a known sequence at the first wireless device, such as the transmitter, and the second wireless device, such as the receiver, may be used for boosting channel estimation and for improvement of phase tracking.

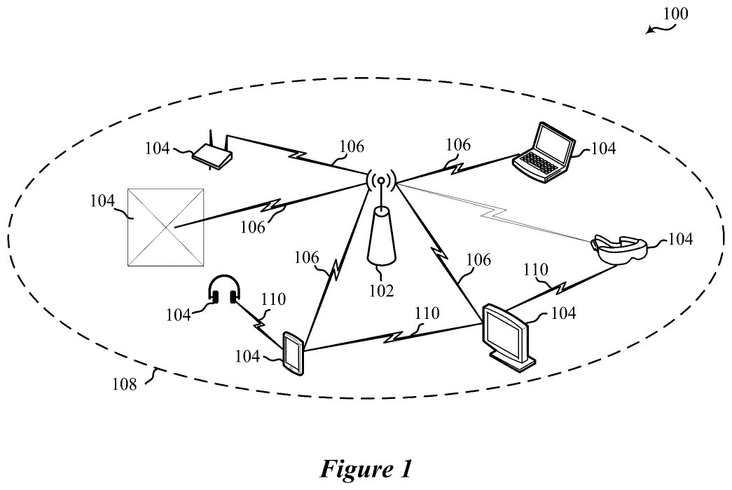

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11 bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP 102 and any quantity of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use implementations associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4 k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

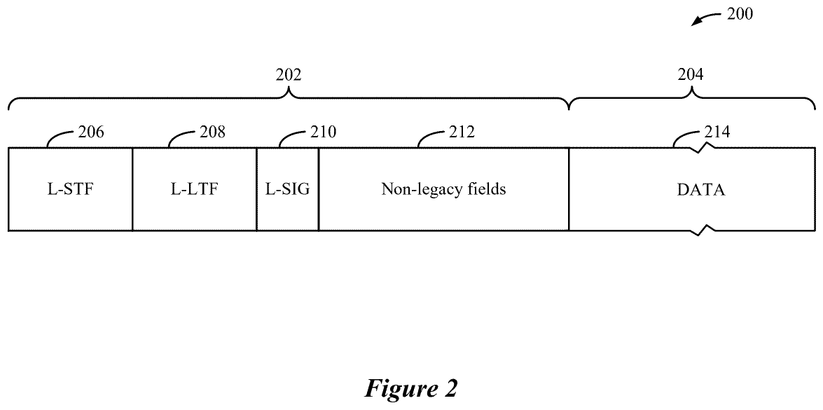

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

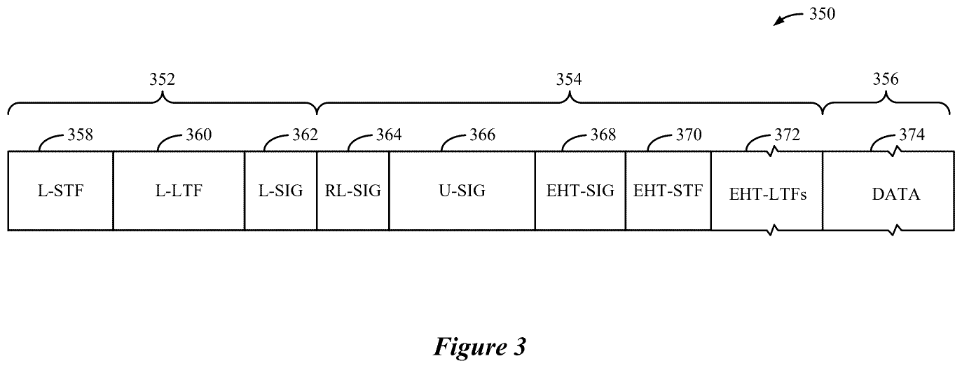

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the quantity of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

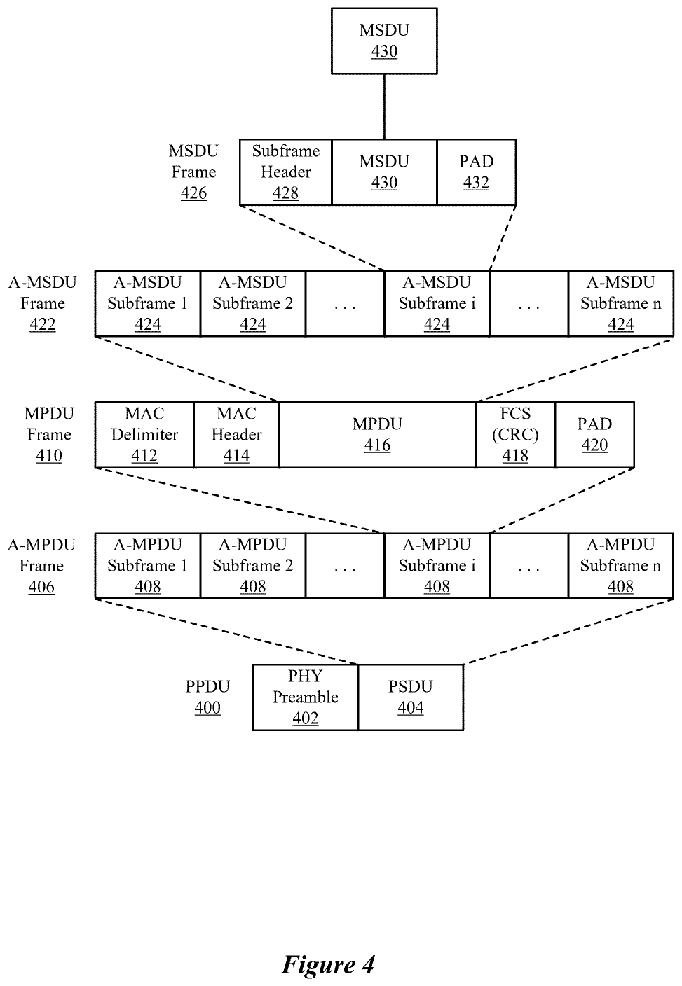

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some implementations, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a quantity of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

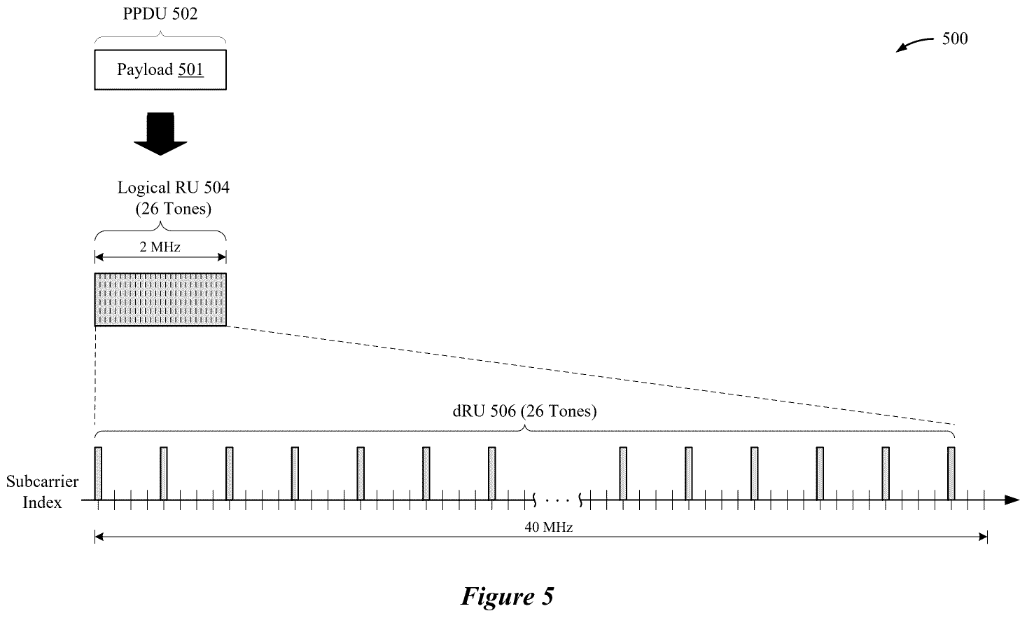

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent an rRU of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for PSD-limited wireless channels. For example, when mapped to an rRU such as logical RU 504, the transmit power of the logical RU 504 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504 is limited by the quantity of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 5 effectively reduces the quantity of tones (of the logical RU 504) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504).

In some examples (not shown in FIG. 5), multiple logical RUs may be mapped to interleaved subcarrier indices of a shared wireless channel. For example, a STA 104 may modulate a portion of the symbols on a quantity of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some implementations, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform (IFFT)) for transmission over a wireless channel. The AP 102 may receive the time-domain signal and reconstruct the dRU 506 (such as by a fast Fourier transform (FFT)). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

In some wireless communication networks, a first wireless device, such as an AP, may transmit a PPDU. The PPDU may include one or more fields that may be unreliable or unusable for a second wireless device, such as a STA. A wireless device supporting ELR operations with relatively low sensitivity may detect one or more signals that include “false alarm” packets. Thus, solutions that allow a wireless device to detect whether a packet is a desired packet are desirable to reduce false alarms or misdetections (MD) and reduce power consumption. In other words, due to a relatively long ELR-SIG duration due to relatively low rate transmission, early dropping of an ELR packet is desired for unintended ELR receivers to save power. Such solutions may allow a wireless device to avoid carrying undesired signals (such as related to parallel multi-hypothesis) for a relatively long period.

In some wireless communications networks, a wireless device may refrain from transmitting fields such as U-SIG1 and U-SIG2 as part of a PPDU preamble (such as U-SIG information may be used for spatial reuse or power saving but may only be useful for a relatively small percentage of user devices that are able to decode it) to reduce overhead and enable early dropping. In some implementations, for protection and power save, one or more wireless devices may receive one or more signals (such as proceeding RTS/CTS and get TxOP info there for NAV setting). In some implementations, transmitting a PPDU preamble including an RL-SIG field may reduce false alarms such that relatively few wireless devices detect false alarms. In some wireless communications networks, a third symbol after an L-LTF field may be a random binary phase-shift keying field or a random QBPSK field. The third symbol after L-LTF may occupy each valid tone of a set of valid tones in a particular tone plan (such as a 1× tone plan).

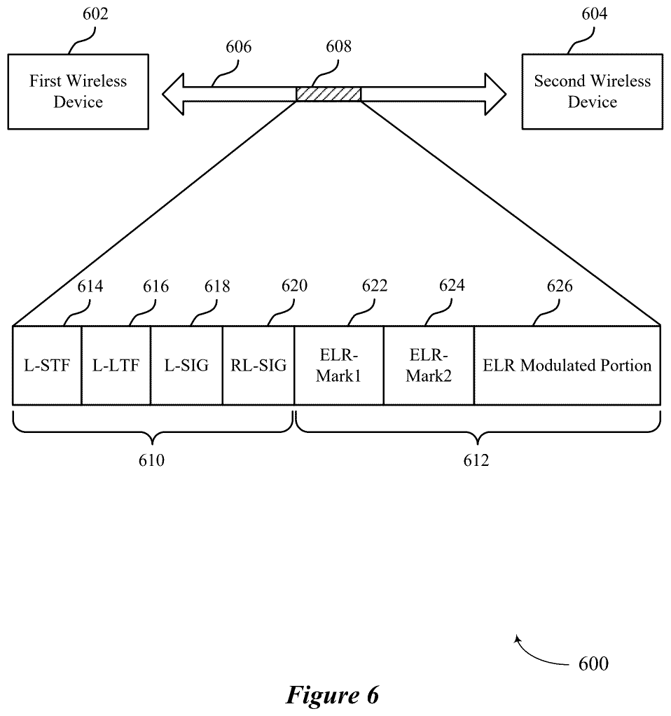

FIG. 6 shows an example of a signaling diagram 600 that supports enhanced long range physical layer protocol data unit design and numerology. In some implementations, the signaling diagram 600 may include or be implemented by aspects described in FIGS. 1-5. For example, the signaling diagram 600 may include one or more wireless devices (such as a first wireless device 602 and a second wireless device 604), which may be respective examples of one or more STAs 104 and one or more APs 102. The first wireless device 602 and the second wireless device 604 may communicate via a wireless connection 606. For example, the first wireless device 602 and the second wireless device 604 may support transmission and reception of a PPDU 608 via the wireless connection 606. The PPDU 608 may be an example of the PPDUs described with reference to FIGS. 2-5. In the following description, although operations may be described to be performed or supported by the first wireless device 602, it is appreciated the second wireless device 604 also may support those operations. For example, the second

In some implementations, the first wireless device 602 may transmit the PPDU 608 to the second wireless device 604. The PPDU 608 may have an ELR signature based PPDU format design (such as a PPDU format design including an ELR mark sequence). In some implementations, ELR may refer to “enhanced long range” formats. The PPDU 608 may include one or more portions. For example, a first portion 610 of the PPDU 608 may include fields such as an L-STF field 614, an L-LTF field 616, an L-SIG field 618, RL-SIG field 620. A second portion 612 of the PPDU 608 may include a first ELR mark field 622, a second ELR mark field 624, and an ELR modulated portion 626. The ELR modulated portion 626 may include one or more fields of the PPDU 608. Further, the PPDU 608 may include a preamble portion and a payload portion (such as different from the first portion 610 and the second portion 612). The preamble portion may include fields included in the first portion 610, the first ELR mark field 622, the second ELR mark field 624, one or more first fields of the ELR modulated portion, or any combination thereof. The payload portion may include one or more second fields of the ELR modulated portion, including an ELR data portion.

In some implementations, the first wireless device 602 may modulate the first ELR mark field 622, the second ELR mark field 624, or both according to a QBPSK modulation scheme (such as to reduce instance of false alarms). The QBPSK modulation scheme may be similar to a BPSK modulation scheme, but with 90-degree rotation. In some implementations, this may allow a receiving device (such as the second wireless device 604) to differentiate the ELR mark fields from a repeated HE signal A field and a U-SIG field from a different PPDU.

For example, the first wireless device 602 may modulate the first ELR mark field 622 according to a QBPSK modulation scheme. Additionally, or alternatively, the first wireless device 602 may modulate the first ELR mark field 622 such that every other tone is populated (and also such that tones interposed between populated tones are unpopulated). In some implementations, populating every other tone may boost a set of populated tones (such as by 3 dB) and also may reduce false alarm occurrences (such as by 3 dB). The first wireless device 602 may modulate the second ELR mark field 624 according to a QBPSK modulation scheme or according to a BPSK modulation scheme. As with the first ELR mark field 622, first wireless device 602 may modulate the second ELR mark field 624 such that every other tone is populated. In some implementations, the first wireless device 602 may support improved frequency tracking by using simple repetition procedures.

To allow the second wireless device 604 to differentiate from a QBPSK modulated HT signal 2 or a VHT signal A2, the first wireless device 602 may construct an ELR mark sequence (such as including the first ELR mark field 622, the second ELR mark field, or both) based on a threshold (such as maximum) hamming distance associated with the QBPSK modulated HT signal 2 and the VHT signal A2. For example, in the last 12 bits of the QBPSK modulated HT signal 2 or the VHT signal A2, there may be 6 tail bits. Thus, the set of 12 bits may use 2⁶=64 combinations among 2¹²=4096 possibilities. The first wireless device 602, the second wireless device 604, or both may select the ELR mark sequence from the rest of the possibilities. Additionally, or alternatively, to allow the second wireless device 604 to differentiate from such signals, the first wireless device 602 also may transmit (or carry), in the ELR mark sequence, an indication of a BSS coloring, a BSS identifier, uplink and downlink information for power saving, or any combination thereof.

The PPDU 608 may have an ELR PPDU format according to one or more options. In any implementation, the PPDU 608 may include fields of the first portion 610 and one or more ELR mark sequence fields (such as the first ELR mark field 622 and the second ELR mark field 624). In each option, the ELR modulated portion 626 may differ. In some implementations, ELR-SIG may refer to an ELR signal field, or an ELR signaling field. Further, in some examples, the ELR mark sequence may be referred to as a signature field. Table 1 shows some details on ELR-SIG contents that may be used for ELR data demodulation at an intended receiver (such as the second wireless device 604) and for power save at any unintended receivers.

In a first option, the ELR modulated portion 626 may include an ELR-SIG field (such as having a one-segment structure) after the ELR mark sequence fields, followed by an ELR data field. In some implementations, both the ELR-SIG field and the ELR-data field may have or correspond to a legacy tone plan (such as a 1× tone plan). The first option may allow a channel estimation boost for demodulating the ELR modulated portion 626 without transmitting additional STF and LTF symbols. In some implementations, the ELR-SIG field may be positioned, in the PPDU 608, right after the ELR-mark sequence such that the ELR-SIG field may benefit from improved channel estimation and a finer carrier frequency offset estimate due to the ELR-mark sequence.

In a second option, the ELR modulated portion 626 may include, after the ELR mark sequence fields, an ELR-STF field (optional), an ELR-LTF field, and an ELR-SIG field (such as having a two-segment structure), followed by an ELR data field. In some implementations, both the ELR-SIG field and the ELR-data field may have or correspond to a tone plan associated with 4× symbol duration (such as a 4× tone plane) as discussed in one or more standards (such as introduced in 802.11ax).

In a third option, the ELR modulated portion 626 may include, after the ELR mark sequence fields, an ELR-SIG field, an ELR-STF field (optional) and an ELR-LTF field, (such as having a two-segment structure), followed by an ELR data field. In some implementations, the ELR-SIG field may have or correspond to a legacy tone plan (such as a 1× tone plan) and the ELR-data field may have or correspond to a 4× tone plan. In some implementations, the ELR-SIG field may be positioned, in the PPDU 608, immediately following the ELR-mark sequence such that the ELR-SIG field may benefit from the improved channel estimation and a finer carrier frequency offset estimate due to the ELR-mark sequence.

TABLE 1
ELR-SIG Content

| Field | Subfield | Bits | Comments |
|---|---|---|---|
| ELR- | Version | 2 | |
| SIG | Number | | |
| | UL/DL | 0-1 | Can be carried over ELR-marks |
| | BSS color | 0-6 | Can be carried over ELR-marks |
| | Length | 6~8 | Unit in symbol (4x symbol or equivalent) |
| | STA ID | 6~11 | Compressed or special ID for ELR users |
| | LDPC/BCC | 1 | |
| | BF | 0~1 | ? |
| | MCS | 2 | |
| | CRC | 4 | |
| | Tail | 6 | |
| | Total | 27-34~43 | About 36-44~56 us |
| | | bits | |

In some implementations, an ELR signature based PPDU format may use the ELR-mark sequence to identify an ELR packet (such as the ELR PPDU). In some implementations, the ELR-mark sequence may be a sequence that is known to the receiver (such as the second wireless device 604). In some implementations, the PPDU 608 may include two signature symbols (such as two ELR mark fields).

To enable the second wireless device 604 to perform an early drop of the PPDU 608 (such as before parsing or decoding the entire PPDU), the ELR-mark sequence may include additional information. The additional information may include a BSS coloring or a BSS identifier that are known to both a transmitter and a receiver (such as known to the first wireless device 602 and the second wireless device 604). This may result in reduced false alarms from another BSS (such as due to unintended PPDUs received from the OBSS). For example, each BSS coloring of a set of BSS colorings, each BSS identifier value of a set of BSS identifier values, or both, may correspond to a sequence among a set of orthogonal sequences. In some implementations, two ELR-mark symbols (such as fields) may have a total of 96 or 104 data tones. Thus, each BSS color value of a 6 bit BSS color value may be linked to one of a set of length-64 or length-96 Hadamard sequences or other orthogonal sequences, which may be transmitted by 64 or 96 data tones among 96 or 104 available data tones.

In some implementations, the ELR-mark sequence also may include (such as carry) one bit of information by its polarity for a power saving procedure. For example, the one bit of information may be used as an uplink or a downlink bit or a modulation and coding scheme bit for the ELR-SIG field. In some implementations, ELR-Mark symbols including (such as carrying) a sequence known to the first wireless device 602 and the second wireless device 604 may be used to improve channel estimation and phase tracking.

In some implementations, the PPDU 608 may have a candidate ELR PPDU format of a set of candidate ELR PPDU formats. Each candidate ELR PPDU format may correspond to a combination of a pair of tone plans, a first tone plan for the ELR-SIG field and a second tone plan for the ELR-data field. For example, the first tone plan and the second tone plan may both be respective examples of legacy tone plans (such as ELR-SIG with 1× symbol and ELR-data with 1× symbol). In another example, the first tone plan may be an example of a 1× tone plan and the second tone plan may be an example of a 4× tone plan (such as ELR-SIG with 1× symbol and ELR-data with 4× symbol). In yet another example, the first tone plan and the second tone plan may both be respective examples of 4× tone plans (such as ELR-SIG with 4× symbol and ELR-data with 4× symbol).

In some implementations, the first wireless device 602 may modulate the ELR modulated portion 626 according to an MCS (such as MCS0, MCS14, MCS15), according to a duplication procedure, or both. The MCS may be associated with the duplication procedure. In some implementations, the first wireless device 602 may select the MCS from a set of MCSs, select the duplication procedure from a set of duplication procedures, or both, based on a target data rate, a target quantity of repetitions (or duplications), a resource unit size, or any combination thereof. In some implementations, the first wireless device 602 may modulate the ELR modulated portion 626 based on an ELR target. For example, if the first wireless device 602 transmits the PPDU 608 over 2.4 GHz, the ELR target may correspond to a first threshold data rate (such as a minimum data rate of about 1 Megabit per second (Mbps), or a 9 dB enhancement). If the first wireless device 602 transmits the PPDU 608 over 5 GHz or 6 GHz, the ELR target may correspond to a second threshold data rate (such as a minimum data rate of about 1.5 Mbps, or a 6 dB enhancement). In the following description of the one or more duplication procedures, in some implementations, repetitions may be referred to as duplications and vice versa.

In some implementations, the first wireless device 602 may modulate the ELR modulated portion 626 according to a time domain duplication procedure (such as with MCS0). For example, the first wireless device 602 may support one or more data rates (such as relatively lower data rates) using time domain repetition of one or more OFDM symbols (such as 1× or 4× symbol). Each repetition of a set of repetitions (such as OFDM symbol repetitions) may be associated with (such as may correspond to) a respective guard interval. Each respective guard interval may have or may be associated with a particular time length (such as 0.8 microseconds, 1.6 microseconds, 3.2 microseconds). In some implementations, each repetition may include a same set of coded bits. In some implementations, each repetition of the set of repetitions may have a same pilot mapping and may have a same polarity (such as to accommodate phase tracking across the set of repetitions). In some implementations, a single repetition symbol (such as 1× symbol) may have one or more tones (such as 52 or 56 tones). In some implementations, the first wireless device 602 may achieve a target data rate by selecting a particular quantity of repetitions, as shown in Table 2.

TABLE 2
Time Domain Duplication (Duplicate Guard Interval) Data Rates

| | | | | TD Duplication: Data Rate (Mbps) | | | |
|---|---|---|---|---|---|---|---|
| 20 | FFT | | GI | 2x | 4x | 6x | 8x |
| MHz | size | Ntones | (us) | DUP | DUP | DUP | DUP |
| 1x | 64 | 52 | 0.8 | 3 | 1.5 | 1 | 0.75 |
| symbol | | | | | | | |
| 4x | 256 | 242 | 0.8 | 4.3 | 2.15 | 1.43 | 1.08 |
| symbol | | | | | | | |

In some implementations, each repetition may include a same set of coded bits. The first wireless device 602 may apply a respective interleaving procedure on each repetition of the set of repetitions (such as for increased diversity) and may refrain from applying an interleaving procedure on a subset of the set of repetitions. For example, the first wireless device 602 may apply a first interleaving procedure on a first half of the set of repetitions and may refrain from interleaving a second half of the set of repetitions (such as for a set of eight repetitions, the first interleaving procedure is applied on the first four repetitions, and is not applied on the last four repetitions, or vice versa). In another example, the first wireless device 602 may apply the first interleaving procedure on each odd repetition of the set of repetitions and may refrain from interleaving each even repetition of the set of repetitions (such as for a set of eight repetitions, the first interleaving procedure is applied on repetitions 1, 3, 5, and 7, and is not applied on repetitions 2, 4, 6, and 8, or vice versa). In yet another example, the first wireless device 602 may apply a different interleaving procedure on each repetition of the set of repetitions (such as “no interleaving” being considered a particular different interleaving procedure).

In some implementations of the time domain duplication procedure, each repetition of the set of repetitions may be associated with a single guard interval (such as a common guard interval). This may reduce the overhead used for guard interval transmission as in Table 3 which shows example data rates associated with the time domain duplication procedure with a common guard interval. In some implementations, time domain duplication with four repetitions of a single guard interval may be equivalent to a four-tone symbol where every 4th tone is populated. In some implementations, each repetition may include a same set of coded bits. In some implementations, each repetition of the set of repetitions may have a same pilot mapping and may have a same polarity (such as to accommodate phase tracking across the set of repetitions).

In some implementations, the first wireless device 602 may modulate the ELR modulated portion 626 according to a hybrid time domain duplication procedure. For example, each block of a set of blocks may include a respective guard interval, but each repetition of a set of repetitions within each block may be associated with a common guard interval for the block (such as the respective guard interval for each block). Thus, the first wireless device 602 may perform an eight-repetition duplication procedure, where each repetition has a same guard interval, by including two four-repetition blocks (with a same guard interval) in a single block, which is equivalent to every fourth tone is populated in 4× tone plan, and where a second four-repetition block is a repetition of a first four-repetition block.

TABLE 3
Time Domain Duplication (Common Guard Interval) Data Rates

| | | | | TD Duplication: Data Rate (Mbps) | | | |
|---|---|---|---|---|---|---|---|
| 20 | FFT | | GI | 2x | 4x | 6x | 8x |
| MHz | size | Ntones | (us) | DUP | DUP | DUP | DUP |
| 1x | 64 | 56 | 0.8 | 3.6 | 1.91 | 1.3 | 0.98 |
| symbol | | | | | | | |
| 4x | 256 | 242 | 0.8 | 4.43 | 2.25 | 1.5 | 1.13 |
| symbol | | | | | | | |

In some implementations, the first wireless device 602 may modulate the ELR modulated portion 626 according to a coded-bits duplication procedure (such as with MCS0). For example, in accordance with coded bits duplication, the first wireless device 602 may concatenate an outer code (such as a binary convolutional code (BCC), a low-density parity check (LDPC) coding, or both) with an inner code (such as a repetition coding). The first wireless device 602 may perform a block-wise (or blockwise) repetition procedure (such as repeating or duplicating blocks), before a BCC or LDPC interleave procedure, based on concatenating the outer code with the inner code. For example, the first wireless device 602 may reuse a BCC or LDPC interleaver (such as a regular BCC or LDPC interleaver) across a bandwidth associated with the first wireless device 602 to perform the block-wise repetition procedure. The first wireless device 602 may achieve (such as harvest) frequency diversity gain based on (such as when) repetition combining. Thus, the first wireless device 602 may perform communications with improved tone efficiency, with flexible repetition to support one or more data rates (such as different data rates), or any combination thereof. In some implementations, the first wireless device 602 may support one or more data rates (such as relatively lower data rates) using coded-bits duplication (such as without fractional symbol issue). In some implementations, the first wireless device 602 may perform communications with a similar efficiency when performing coded-bits duplication and the first time-domain duplication method (such as due to separate GI per symbol). For example, the first wireless device 602 may use a GI having value 0.8 microseconds, 1.6 microseconds, 3.2 microseconds, and so on. The first wireless device 602 may apply such repetitions to one or more tone plans or symbol durations (such as 1× symbol or 4× symbol), as shown in Table 4.

TABLE 4
Coded-bits Duplication Data Rates

| | | | | Coded-bits Duplication: Data | | | |
|---|---|---|---|---|---|---|---|
| | | | | Rate (Mbps) | | | |
| 20 | FFT | | GI | 2x | 4x | 6x | 8x |
| MHz | size | Ntones | (us) | DUP | DUP | DUP | DUP |
| 1x symbol | 64 | 56 | 0.8 | 3.25 | 1.625 | 1.08 | 0.81 |
| 4x symbol | 256 | 242 | 0.8 | 4.3 | 2.15 | 1.43 | 1.08 |

In some implementations, coded-bits duplication may include using block-wise repetition to increase (such as maximize) frequency diversity and limit (such as decrease or minimize) decoding latency at the receiver side. The first wireless device 602 may apply coded-bits duplication using a block size L according to one or more options. For example, in some implementations, the first wireless device 602 may transmit blocks with a fixed block size L, and in some other implementations, the first wireless device 602 may transmit blocks with a variable block size L. The first wireless device 602 may transmit the blocks according to the block size L based on a data rate configured at the first wireless device 602, a quantity of repetitions associated with the blocks, (such as the first wireless device 602 may transmit a quantity of blocks at the data rate equal to the quantity of repetitions), one or more coding schemes, a resource unit size, or any combination thereof. In some implementations, the first wireless device 602 may use a set of pilot tones and a total quantity of data tones based on the block size L, the data rate, the quantity of repetitions associated with the blocks, one or more coding schemes, a resource unit size, or any combination thereof. The first wireless device 602 may use the set of pilot tones and the data tones for communications with one or more other wireless devices. Thus, the first wireless device 602 may perform an eight-repetition duplication procedure (such as 8× duplication).

In a first option, the first wireless device 602 may transmit blocks with a fixed block size L in any implementation (such as regardless of the data rate, the quantity of repetitions, the one or more coding schemes, and the resource unit size). The first wireless device 602 may select the fixed block size L to increase frequency diversity and limit decoding latency (such as L may be 1, 2, 4, 8, 16, and so on, or L may be one byte in length, L=8). For example, the first wireless device 602 may select the block size to be a fixed block size (such as L=1) and may set an LDPC tone mapping distance to a value based on the quantity of repetitions (such as Dtm=Dtm_original*N, where Dtm_orginal is defined in a configuration of the first wireless device 602 associated with non-ELR PPDU modes or formats, and where N is a quantity of repetitions or duplications). In some implementations, the first wireless device 602 may select the fixed block size to increase a tone plan efficiency. In some implementations, duplicated coded bits may potentially cross OFDM symbol boundaries. In some implementations with a lower data rate, maintaining a symbol boundary for one or more repetitions may be relatively difficult.

In a second option, the first wireless device 602 may transmit blocks with a fixed block size L based on a resource unit size only (such as for varying data rate, quantity of repetitions, and coding schemes). For example, for a resource unit having size 242 (RU242), the first wireless device 602 may select a fixed block size L such that L=floor(234/LCM(2, 4, 6, 8))=9. Thus, the total quantity of data tones may be 216 tones, and the remaining tones may be used as pilot tones. For an RU106, the first wireless device 602 may select a fixed block size L such that L=floor(102/LCM(2, 4, 6, 8))=4. Thus, the total quantity of data tones may be 96 tones and the remaining tones may be used as pilot tones. For an RU56, the first wireless device 602 may select a fixed block size L such that L=floor(52/LCM(2, 4, 6, 8))=2. Thus, the total quantity of data tones may be 48 tones and the remaining tones may be used as pilot tones. For an RU52, the first wireless device 602 may select a fixed block size L such that L=floor(48/LCM(2, 4, 6, 8))=2. Thus, the total quantity of data tones may be 48 tones and the remaining tones may be used as pilot tones. For an RU26, the first wireless device 602 may select a fixed block size L such that L=floor(24/LCM(2, 4, 6, 8))=1, Thus, the total quantity of data tones may be 24 tones. In some implementations, when using the second option, the first wireless device 602 may transmit a set of duplicated coded bits within a single OFDM symbol (such as ensuring that duplicated coded bits always finish in one OFDM symbol).

In a third option, the first wireless device 602 may transmit blocks with a variable block size L based on the resource unit size and the data rate (or based on the resource unit size and the quantity of repetitions) (such as for varying and coding schemes). For a given resource unit size and a given data rate, the first wireless device 602 may select a block size to increase efficiency while transmitting (such as fitting) duplicated coded bits within a single OFDM symbol. For example, with 52 tones in a legacy tone plan or RU52 in a 4× tone plan, the first wireless device 602 may select the block size L such that L-48/4=12 for four-repetition duplication, and thus the total quantity of data tones may be 48 tones. Alternatively, the first wireless device 602 may select the block size L such that L=48/6=8 for six-repetition duplication, and thus the total quantity of data tones may be 48 tones. In another example, with RU242 in a 4× tone plan, the first wireless device 602 may select the block size L such that L=floor(234/4)=58 for four-repetition duplication and thus the total quantity of data tones may be 232 tones, and the remaining tones may be used as pilot tones. Alternatively, the first wireless device 602 may select a block size L such that L=floor(234/8)=29 for eight-repetition duplication and thus, the total quantity of data tones may be 232 tones, and the remaining tones may be used as pilot tones. In some implementations, when using the third option, the first wireless device 602 may transmit a set of duplicated coded bits within a single OFDM symbol.

In any implementation, the first wireless device 602 applying coded-bits duplication may avoid use of fractional symbols. Further, the first wireless device 602 may perform transmissions according to one or more different data rates based on using one or more different quantities of repetitions. In some implementations, the first wireless device 602 applying coded-bits duplication may perform communication more efficiently when compared to other duplication schemes (such as when applying a 4× tone plan). In some implementations, the first wireless device 602 may apply power boosting for pilot tones or may use other tones (such as redundant tones) to increase a quantity of usable pilot tones (such as additional pilot tones). In some implementations, the first wireless device 602 may apply a power boosting procedure on the pilot tones (such as 3 dB boosting to enhance phase tracking).

In some implementations, the first wireless device 602 may modulate the ELR modulated portion 626 according to a frequency domain duplication procedure (such as with MCS0 or with MCS1). In a first alternative, a data rate for the PPDU 608 corresponding to the frequency domain duplication procedure may be calculated in Mbps (such as 24/14.4=1.67 Mbps, 48/14.4=3.33 Mbps). For a resource unit having size 52 (such as RU52), for a four-repetition duplication procedure (such as duplication by 4×), and for a first MCS (such as BPSK 1/2 or QPSK 1/2), a data rate may be 1.7 Mbps or 3.33 Mbps. For a resource unit having size 26 (such as RU26), for a nine-repetition duplication procedure (such as duplication by 9×), and for a second MCS (such as BPSK 1/2 or QPSK 1/2), a data rate may be 0.8 Mbps or 1.67 Mbps. In a second alternative, a data rate for the PPDU 608 corresponding to the frequency domain duplication procedure may be calculated in Mbps (such as 24/13.6=1.76 Mbps, 25/13.6=1.84 Mbps, 48/13.6=3.53 Mbps). For example, the second alternative may include four resource units having size 52 (such as four RU52s) and may include modulating according to a MCS (such as MCS0, MCS1) with four times repetitions. Further, the second alternative may include two resource units having size 106 (such as two RU106s) and may include modulating according to the third MCS (such as MCS15) with two times repetitions. In another example, the second alternative may include a nine-repetition duplication of a resource unit having size 26 (such as RU26), and may include modulating according to a fourth MCS (such as MCS0). Table 5 illustrates further details regarding data rates and numerologies associated with the frequency domain duplication procedure. In some implementations, if the first wireless device 602 modulates the ELR modulated portion 626 according to the frequency domain duplication procedure, the first wireless device 602 may support 4× tone plans for the ELR-SIG field and the ELR-data field. Thus, the first wireless device 602 may perform an eight-repetition duplication procedure (such as 8× duplication).

TABLE 5
Frequency Domain Duplication Numerology and Data Rates

| N-DUP | 4x DUP | | | 8x DUP | | | 6x DUP | 2x DUP |
|---|---|---|---|---|---|---|---|---|
| GI (us) | 0.8 | 1.6 | 3.2 | 0.8 | 1.6 | 3.2 | 1.6 | 1.6 |

| RU DUP | RU52 4x DUP | | | RU26 9x DUP | | | RU26 6x | RU106 |
|---|---|---|---|---|---|---|---|---|
| MCS0 | | | | | | | DUP ? | 2xDUP |
| | 1.76 | 1.67 | 1.5 | 0.88 | 0.83 | 0.75 | | 3.54 |
| MCS14 | 4 RU52 formed | | | RU52 DUP 4x, | | | RU52 DUP | RU242 with |
| based | MCS14 | | | each with | | | 3x, each | BPSK + DC |
| DCM + DUP | | | | BPSK + DCM | | | with | M |
| | | | | | | | BPSK + DCM | |
| | 1.76 | 1.67 | 1.5 | 0.88 | 0.83 | 0.75 | | 4.03 |
| | 2 RU106 formed | | | | | | | |
| | MCS14 | | | | | | | |
| | 1.84 | 1.74 | 1.56 | | | | | |

In some implementations, the first wireless device 602 may modulate the ELR modulated portion 626 according to a distributed tone resource unit (dRU) procedure (such as with MCS0). In some implementations, the dRU procedure may be referred to as a distributed tone transmission procedure. Table 6 illustrates details regarding data rates associated with the dRU procedure. For example, the first wireless device 602 may spread a distributed tone resource unit having size 52 or 26 (such as dRU52 or dRU26) over 20 MHz (such as to achieve a target power boost and range extension). This may reduce power spectral density limitations associated with PPDU transmission. In some implementations, if the first wireless device 602 modulates the ELR modulated portion 626 according to the dRU procedure, the first wireless device 602 may support 4× tone plans for the ELR-SIG field and the ELR-data field. Thus, the first wireless device 602 may perform an eight-repetition duplication procedure (such as 8× duplication).

TABLE 6
Distributed Tone Data Rates

| | | | | | | | | 6x | 2x |
|---|---|---|---|---|---|---|---|---|---|
| N-DUP | | 4x DUP | | | 8x DUP | | | DUP | DUP |
| GI (us) | | 0.8 | 1.6 | 3.2 | 0.8 | 1.6 | 3.2 | 1.6 | 1.6 |
| dRU | dRU52, | dRU52 | | | dRU26 | | | | dRU106 |
| | dRU26 | 1.76 | 1.67 | 1.5 | 0.88 | 0.83 | 0.75 | | 3.54 |

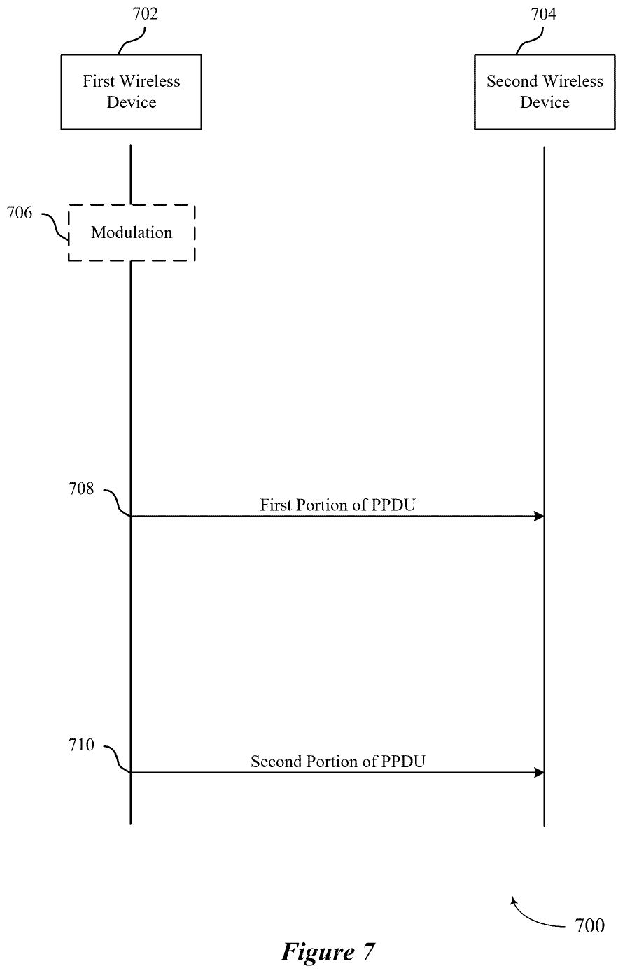

FIG. 7 shows an example of a process flow 700 that supports enhanced long range physical layer protocol data unit design and numerology. The process flow 700 includes a first wireless device 702 and a second wireless device 704, which may be examples of one or more STAs 104 or one or more APs 102 as described with respect to FIGS. 1 and 6. In the following description of the process flow 700, the operations between the first wireless device 702 and the second wireless device 704 may be performed in a different order than the example order shown. Some operations also may be omitted from the process flow 700, and other operations may be added to the process flow 700. Further, although some operations or signaling may be shown to occur at different times for discussion purposes, these operations may actually occur at the same time.

At 706, the first wireless device 702 may optionally perform a modulation procedure, which may be associated with or may include one or more duplication procedures. For example, the first wireless device 702 may modulate a first ELR mark field and a second ELR mark field such that each first tone of a set of first tones is interposed between a respective pair of second tones of a set of second tones, and such that each first tone is populated. The modulation procedure may be based on an MCS. Further, the one or more duplication procedures may include time domain duplication, coded-bits duplication, frequency domain duplication, or a distributed resource unit procedure.

At 708, the first wireless device 702 may transmit, to the second wireless device 704, a first portion of a preamble of a PPDU. The first portion of the preamble may include at least a legacy short training field, a legacy long training field, a legacy signal field, a repeat legacy signal field, or any combination thereof.

At 710, the first wireless device 702 may transmit, to the second wireless device 704, a second portion of the preamble. The second portion of the preamble may include at least the first ELR mark field, the second ELR mark field, and an ELR modulated portion. The first ELR mark field and the second ELR mark field both may be modulated according to a QBPSK modulation scheme. The ELR modulated portion may include an ELR signaling field, an ELR data field, an ELR short training field, an ELR long training field, or any combination thereof. The ELR signaling field may include a version identifier (such as a version number), uplink and downlink information, a basic service set coloring (or color), an indication of a packet length in terms of a quantity of symbols, a wireless device identifier (such as a STA identifier), one or more low density parity check or binary convolution code bits, beamforming information, an indication of a modulation and coding scheme, cyclic redundancy check information, one or more tail bits, or any combination thereof.

The second portion of the preamble may include an ELR mark sequence that includes at least the first ELR mark field, the second ELR mark field, or both. In some implementations, the ELR mark sequence includes an indication that identifies an ELR packet. The ELR mark sequence may indicate a basic service set coloring, a basic service set identifier, or both. Additionally, or alternatively, the ELR mark sequence may indicate a polarity associated with a power saving procedure for the first wireless device 702.

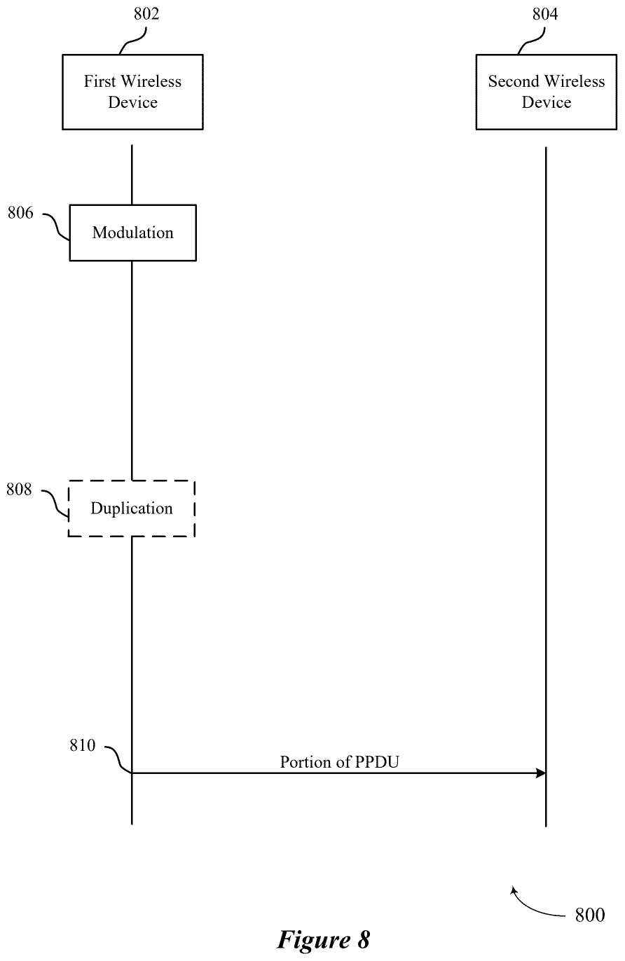

FIG. 8 shows an example of a process flow 800 that supports enhanced long range physical layer protocol data unit design and numerology. The process flow 800 includes a first wireless device 802 and a second wireless device 804, which may be examples of one or more STAs 104 or one or more APs 102 as described with respect to FIGS. 1, 6, and 7. In the following description of the process flow 800, the operations between the first wireless device 802 and the second wireless device 804 may be performed in a different order than the example order shown. Some operations also may be omitted from the process flow 800, and other operations may be added to the process flow 800. Further, although some operations or signaling may be shown to occur at different times for discussion purposes, these operations may actually occur at the same time.

At 806, the first wireless device 802 may modulate a portion of a PPDU according to a modulation scheme of a set of modulation schemes. The portion of the PPDU may include at least an ELR signaling field and an ELR data field. In some implementations, the first wireless device 802 may select the modulation scheme based on a target data rate. The modulation scheme may be associated with a duplication procedure for the portion of the PPDU.

At 808, the first wireless device 802 may perform a duplication procedure. For example, the first wireless device 802 may perform modulate the portion of the PPDU in accordance with the duplication procedure. Further, the duplication procedure may include time domain duplication, coded-bits duplication, frequency domain duplication, or a distributed resource unit procedure.

In some implementations, the duplication procedure may be a time domain duplication procedure where each repetition of a set of repetitions corresponding to the portion of the PPDU is associated with a respective guard interval. The first wireless device 802 may interleave a first subset of the set of repetitions based on one or more interleaving parameters and may refrain from interleaving a second subset of the set of repetitions. In some implementations, the duplication procedure may be a time domain duplication procedure where each repetition of a set of repetitions corresponding to the portion of the PPDU is associated with a same guard interval. In some implementations, each block of a set of blocks corresponding to the portion of the PPDU may be associated with a respective (such as different or unique) guard interval and each repetition of a set of repetitions within each block may be associated with a same guard interval. In some implementations, each repetition of a set of repetitions may be associated with a same pilot mapping (or each repetition having a same pilot sequence on pilot tones) and a same polarity.

In some implementations, the duplication procedure may be a coded-bits duplication procedure that includes a repetition of one or more blocks. The first wireless device 602 may perform the coded-bits duplication procedure before an interleaving procedure. In some implementations, a block size (or block length) of the one or more blocks may be based on the target data rate, a quantity of repetitions of the one or more blocks, one or more coding schemes, a resource unit size, or any combination thereof. In some implementations, the duplication procedure may be a frequency domain duplication procedure. In some other implementations, the duplication procedure may be a distributed tone resource unit procedure.

At 810, the first wireless device 802 may transmit, to the second wireless device 804, the portion of the PPDU in accordance with the modulation scheme. In some implementations, the first wireless device 802 may transmit the portion of the PPDU based on the duplication procedure or based on modulating the portion of the PPDU according to the modulation scheme and in accordance with the duplication procedure.

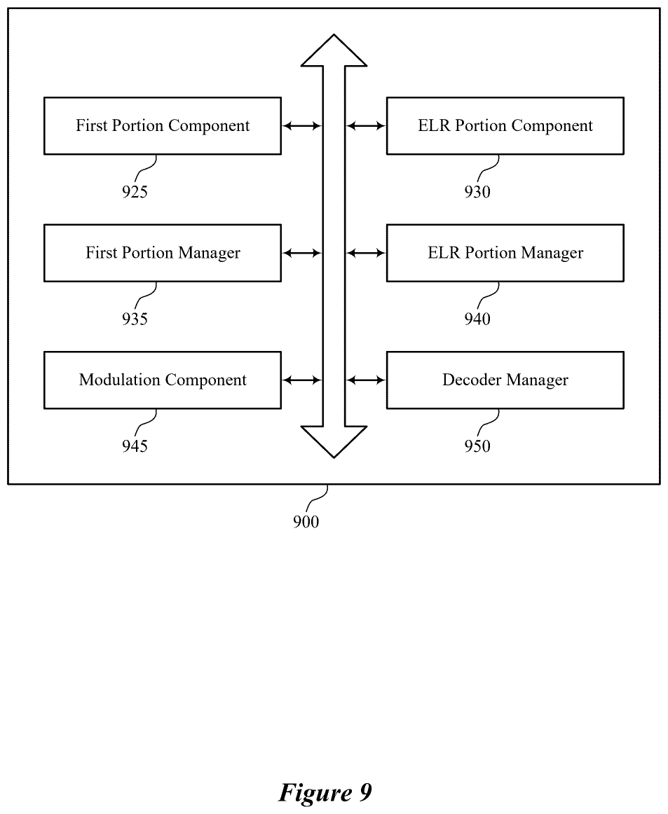

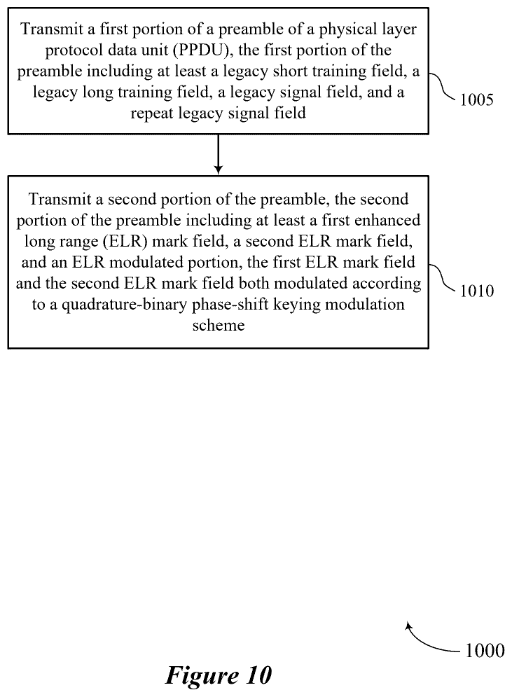

FIG. 9 shows a block diagram of an example wireless communication device 900 that supports enhanced long range physical layer protocol data unit design and numerology. In some implementations, the wireless communication device 900 is configured to perform the processes 1000, 1100, 1200, and 1300 described with reference to FIGS. 10, 11, 12, and 13, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 900 can be configurable or configured for use in an AP or STA, such as the AP 102 or the STA 104 described with reference to FIG. 1. In some other examples, the wireless communication device 900 can be an AP or STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some implementations, the wireless communication device 900 also includes or can be coupled with one or more application processors which may be further coupled with one or more other memories. In some implementations, the wireless communication device 900 further includes a user interface (UI) (such as a touchscreen or keypad) and a display, which may be integrated with the UI to form a touchscreen display that is coupled with the processing system. In some implementations, the wireless communication device 900 may further include one or more sensors such as, for example, one or more inertial sensors, accelerometers, temperature sensors, pressure sensors, or altitude sensors, that are coupled with the processing system. In some implementations, the wireless communication device 900 further includes at least one external network interface coupled with the processing system that enables communication with a core network or backhaul network that enables the wireless communication device 900 to gain access to external networks including the Internet.

The wireless communication device 900 includes a first portion component 925, an ELR portion component 930, a first portion manager 935, an ELR portion manager 940, a modulation component 945, and a decoder manager 950. Portions of one or more of the first portion component 925, the ELR portion component 930, the first portion manager 935, the ELR portion manager 940, the modulation component 945, and the decoder manager 950 may be implemented at least in part in hardware or firmware. For example, one or more of the first portion component 925, the ELR portion component 930, the first portion manager 935, the ELR portion manager 940, the modulation component 945, and the decoder manager 950 may be implemented at least in part by at least a processor or a modem. In some implementations, portions of one or more of the first portion component 925, the ELR portion component 930, the first portion manager 935, the ELR portion manager 940, the modulation component 945, and the decoder manager 950 may be implemented at least in part by a processor and software in the form of processor-executable code stored in memory.

The wireless communication device 900 may support wireless communications in accordance with examples as disclosed herein. The first portion component 925 is configurable or configured to transmit a first portion of a preamble of a PPDU, the first portion of the preamble including at least a legacy short training field, a legacy long training field, a legacy signal field, and a repeat legacy signal field. The ELR portion component 930 is configurable or configured to transmit a second portion of the preamble, the second portion of the preamble including at least a first ELU mark field, a second ELR mark field, and an ELR modulated portion, the first ELR mark field and the second ELR mark field both modulated according to a QBPSK modulation scheme.

In some implementations, to support transmitting the second portion of the preamble, the ELR portion component 930 is configurable or configured to transmit the second portion of the preamble that includes an ELR signaling field and an ELR data field.

In some implementations, to support transmitting the second portion of the preamble, the ELR portion component 930 is configurable or configured to transmit the second portion of the preamble that includes an ELR short training field and an ELR long training field.

In some implementations, the ELR signaling field includes a version identifier, uplink information, downlink information, a basic service set coloring, an indication of a length or a quantity of symbols, a wireless device identifier, one or more low density parity check or binary convolution code bits, an indication of a modulation and coding scheme, cyclic redundancy check information, one or more tail bits, or any combination thereof.

In some implementations, the modulation component 945 is configurable or configured to modulate the first ELR mark field and the second ELR mark field such that each first tone of a set of first tones is interposed between a respective pair of second tones of a set of second tones, and such that each first tone is populated.

In some implementations, to support transmitting the second portion of the preamble, the ELR portion component 930 is configurable or configured to transmit the second portion of the preamble that includes an ELR mark sequence that includes at least the first ELR mark field, the second ELR mark field, or both, where the ELR mark sequence includes an indication that identifies an ELR packet.

In some implementations, to support transmitting the second portion of the preamble, the ELR portion component 930 is configurable or configured to transmit the second portion of the preamble that includes an ELR mark sequence that includes at least the first ELR mark field, the second ELR mark field, or both, where the ELR mark sequence indicates a basic service set coloring, a basic service set identifier, or both.

In some implementations, to support transmitting the second portion of the preamble, the ELR portion component 930 is configurable or configured to transmit the second portion of the preamble that includes an ELR mark sequence that includes at least the first ELR mark field, the second ELR mark field, or both, where the ELR mark sequence indicates a polarity associated with a power saving procedure for the first wireless device.

Additionally, or alternatively, the wireless communication device 900 may support wireless communications in accordance with examples as disclosed herein. The first portion manager 935 is configurable or configured to receive a first portion of a preamble of a PPDU, the first portion of the preamble including at least a legacy short training field, a legacy long training field, a legacy signal field, and a repeat legacy signal field. The ELR portion manager 940 is configurable or configured to receive a second portion of the preamble, the second portion of the preamble including at least a first ELU mark field, a second ELR mark field, and an ELR modulated portion, the first ELR mark field and the second ELR mark field both modulated according to a QBPSK modulation scheme.

In some implementations, to support receiving the second portion of the preamble, the ELR portion manager 940 is configurable or configured to receive the second portion of the preamble that includes an ELR signaling field and an ELR data field.

In some implementations, to support receiving the second portion of the preamble, the ELR portion manager 940 is configurable or configured to receive the second portion of the preamble that includes an ELR short training field and an ELR long training field.

In some implementations, the ELR signaling field includes a version identifier, uplink information, downlink information, a basic service set coloring, an indication of a length or a quantity of symbols, a wireless device identifier, one or more low density parity check or binary convolution code bits, an indication of a modulation and coding scheme, cyclic redundancy check information, one or more tail bits, or any combination thereof.

In some implementations, the first ELR mark field and the second ELR mark field are modulated such that each first tone of a set of first tones is interposed between a respective pair of second tones of a set of second tones, and such that each first tone is populated.

In some implementations, to support receiving the second portion of the preamble, the ELR portion manager 940 is configurable or configured to receive the second portion of the preamble that includes an ELR mark sequence that includes at least the first ELR mark field, the second ELR mark field, or both, where the ELR mark sequence includes an indication that identifies an ELR packet.

In some implementations, to support receiving the second portion of the preamble, the ELR portion manager 940 is configurable or configured to receive the second portion of the preamble that includes an ELR mark sequence that includes at least the first ELR mark field, the second ELR mark field, or both, where the ELR mark sequence indicates a basic service set coloring, a basic service set identifier, or both.

In some implementations, to support receiving the second portion of the preamble, the ELR portion manager 940 is configurable or configured to receive, from a first wireless device, the second portion of the preamble that includes an ELR mark sequence that includes at least the first ELR mark field, the second ELR mark field, or both, where the ELR mark sequence indicates a polarity associated with a power saving procedure for the first wireless device.

Additionally, or alternatively, the wireless communication device 900 may support wireless communications in accordance with examples as disclosed herein. The modulation component 945 is configurable or configured to modulate a portion of a PPDU according to a modulation scheme of a set of modulation schemes, the portion of the PPDU including at least an ELU signaling field and an ELR data field, where the modulation scheme is selected based on a target data rate and is associated with a duplication procedure for the portion of the PPDU. In some implementations, the ELR portion component 930 is configurable or configured to transmit the portion of the PPDU in accordance with the modulation scheme.

In some implementations, to support modulating the portion of the PPDU, the modulation component 945 is configurable or configured to modulate the portion of the PPDU according to the modulation scheme in accordance with a time domain duplication procedure, where each repetition of a set of repetitions corresponding to the portion of the PPDU is associated with a respective guard interval.

In some implementations, a first subset of the set of repetitions is interleaved based on one or more interleaving parameters. In some implementations, a second subset of the set of repetitions is not interleaved.

In some implementations, to support modulating the portion of the PPDU, the modulation component 945 is configurable or configured to modulate the portion of the PPDU according to the modulation scheme in accordance with a time domain duplication procedure, where each repetition of a set of repetitions corresponding to the portion of the PPDU is associated with a same guard interval.

In some implementations, to support modulating the portion of the PPDU, the modulation component 945 is configurable or configured to modulate the portion of the PPDU according to the modulation scheme in accordance with a time domain duplication procedure, where each block of a set of blocks corresponding to the portion of the PPDU is associated with a respective guard interval, and where each repetition of a set of repetitions within each block is associated with a same guard interval.

In some implementations, to support modulating the portion of the PPDU, the modulation component 945 is configurable or configured to modulate the portion of the PPDU according to the modulation scheme in accordance with a time domain duplication procedure, where each repetition of a set of repetitions is associated with a same pilot mapping and a same polarity.

In some implementations, to support modulating the portion of the PPDU, the modulation component 945 is configurable or configured to modulate the portion of the PPDU according to the modulation scheme in accordance with a coded-bits duplication procedure that includes a repetition of one or more blocks before an interleaving procedure.

In some implementations, a block size of the one or more blocks is based on the target data rate, a quantity of repetitions of the one or more blocks, one or more coding schemes, a resource unit size, or any combination thereof.

In some implementations, to support modulating the portion of the PPDU, the modulation component 945 is configurable or configured to modulate the portion of the PPDU according to the modulation scheme in accordance with a frequency domain duplication procedure.

In some implementations, to support modulating the portion of the PPDU, the modulation component 945 is configurable or configured to modulate the portion of the PPDU according to the modulation scheme in accordance with a distributed tone resource unit procedure.

Additionally, or alternatively, the wireless communication device 900 may support wireless communications in accordance with examples as disclosed herein. In some implementations, the ELR portion manager 940 is configurable or configured to receive a portion of a PPDU according to a modulation scheme of a set of modulation schemes, the portion of the PPDU including at least an enhanced long range ELR signaling field and an ELR data field, where the modulation scheme is selected based on a target data rate and is associated with a duplication procedure for the portion of the PPDU. The decoder manager 950 is configurable or configured to decode the portion of the PPDU to obtain one or more bits of the ELR signaling field, the ELR data field, or both.

In some implementations, to support receiving the portion of the PPDU, the ELR portion manager 940 is configurable or configured to receive the portion of the PPDU according to the modulation scheme in accordance with a time domain duplication procedure, where each repetition of a set of repetitions corresponding to the portion of the PPDU is associated with a respective guard interval.

In some implementations, a first subset of the set of repetitions is interleaved based on one or more interleaving parameters. In some implementations, a second subset of the set of repetitions is not interleaved.

In some implementations, to support receiving the portion of the PPDU, the ELR portion manager 940 is configurable or configured to receive the portion of the PPDU according to the modulation scheme in accordance with a time domain duplication procedure, where each repetition of a set of repetitions corresponding to the portion of the PPDU is associated with a same guard interval.

In some implementations, to support modulating the portion of the PPDU, the ELR portion manager 940 is configurable or configured to modulate the portion of the PPDU according to the modulation scheme in accordance with a time domain duplication procedure, where each block of a set of blocks corresponding to the portion of the PPDU is associated with a respective guard interval, and where each repetition of a set of repetitions within each block is associated with a same guard interval.

In some implementations, to support modulating the portion of the PPDU, the ELR portion manager 940 is configurable or configured to modulate the portion of the PPDU according to the modulation scheme in accordance with a time domain duplication procedure, where each repetition of a set of repetitions is associated with a same pilot mapping and a same polarity.

In some implementations, to support receiving the portion of the PPDU, the ELR portion manager 940 is configurable or configured to receive the portion of the PPDU according to the modulation scheme in accordance with a coded-bits duplication procedure that includes a repetition of one or more blocks before an interleaving procedure.

In some implementations, a block size of the one or more blocks is based on the target data rate, a quantity of repetitions of the one or more blocks, one or more coding schemes, a resource unit size, or any combination thereof.

In some implementations, to support receiving the portion of the PPDU, the ELR portion manager 940 is configurable or configured to receive the portion of the PPDU according to the modulation scheme in accordance with a frequency domain duplication procedure.

In some implementations, to support receiving the portion of the PPDU, the ELR portion manager 940 is configurable or configured to receive the portion of the PPDU according to the modulation scheme in accordance with a distributed tone resource unit procedure.

FIG. 10 shows a flowchart illustrating an example process 1000 performable by or at a first wireless device that supports enhanced long range physical layer protocol data unit design and numerology. The operations of the process 1000 may be implemented by a first wireless device or its components as described herein. For example, the process 1000 may be performed by a wireless communication device, such as the wireless communication device 900 described with reference to FIG. 9, operating as or within a wireless AP or a wireless STA. In some implementations, the process 1000 may be performed by a wireless AP or a wireless STA, such as one of the APs 102 or the STAs 104 described with reference to FIG. 1.

In some implementations, in 1005, the first wireless device may transmit a first portion of a preamble of a PPDU, the first portion of the preamble including at least a legacy short training field, a legacy long training field, a legacy signal field, and a repeat legacy signal field. The operations of 1005 may be performed in accordance with examples as disclosed herein. In some implementations, aspects of the operations of 1005 may be performed by a first portion component 925 as described with reference to FIG. 9.

In some implementations, in 1010, the first wireless device may transmit a second portion of the preamble, the second portion of the preamble including at least a first ELU mark field, a second ELR mark field, and an ELR modulated portion, the first ELR mark field and the second ELR mark field both modulated according to a QBPSK modulation scheme. The operations of 1010 may be performed in accordance with examples as disclosed herein. In some implementations, aspects of the operations of 1010 may be performed by an ELR portion component 930 as described with reference to FIG. 9.

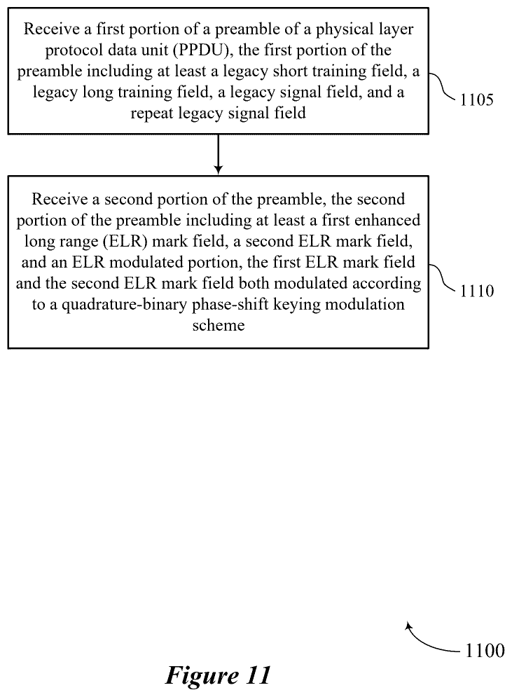

FIG. 11 shows a flowchart illustrating an example process 1100 performable by or at a second wireless device that supports enhanced long range physical layer protocol data unit design and numerology. The operations of the process 1100 may be implemented by a second wireless device or its components as described herein. For example, the process 1100 may be performed by a wireless communication device, such as the wireless communication device 900 described with reference to FIG. 9, operating as or within a wireless AP or a wireless STA. In some implementations, the process 1100 may be performed by a wireless AP or a wireless STA, such as one of the APs 102 or the STAs 104 described with reference to FIG. 1.

In some implementations, in 1105, the second wireless device may receive a first portion of a preamble of a PPDU, the first portion of the preamble including at least a legacy short training field, a legacy long training field, a legacy signal field, and a repeat legacy signal field. The operations of 1105 may be performed in accordance with examples as disclosed herein. In some implementations, aspects of the operations of 1105 may be performed by a first portion manager 935 as described with reference to FIG. 9.

In some implementations, in 1110, the second wireless device may receive a second portion of the preamble, the second portion of the preamble including at least a first ELU mark field, a second ELR mark field, and an ELR modulated portion, the first ELR mark field and the second ELR mark field both modulated according to a QBPSK modulation scheme. The operations of 1110 may be performed in accordance with examples as disclosed herein. In some implementations, aspects of the operations of 1110 may be performed by an ELR portion manager 940 as described with reference to FIG. 9.

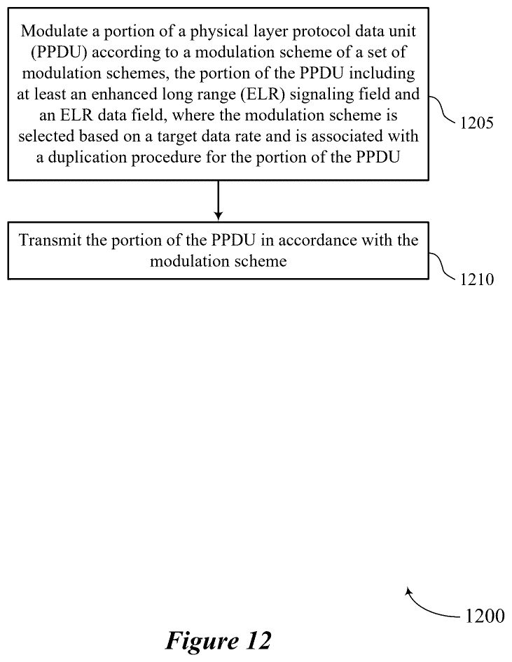

FIG. 12 shows a flowchart illustrating an example process 1200 performable by or at a first wireless device that supports enhanced long range physical layer protocol data unit design and numerology. The operations of the process 1200 may be implemented by a first wireless device or its components as described herein. For example, the process 1200 may be performed by a wireless communication device, such as the wireless communication device 900 described with reference to FIG. 9, operating as or within a wireless AP or a wireless STA. In some implementations, the process 1200 may be performed by a wireless AP or a wireless STA, such as one of the APs 102 or the STAs 104 described with reference to FIG. 1.

In some implementations, in 1205, the first wireless device may modulate a portion of a PPDU according to a modulation scheme of a set of modulation schemes, the portion of the PPDU including at least an ELU signaling field and an ELR data field, where the modulation scheme is selected based on a target data rate and is associated with a duplication procedure for the portion of the PPDU. The operations of 1205 may be performed in accordance with examples as disclosed herein. In some implementations, aspects of the operations of 1205 may be performed by a modulation component 945 as described with reference to FIG. 9.

In some implementations, in 1210, the first wireless device may transmit the portion of the PPDU in accordance with the modulation scheme. The operations of 1210 may be performed in accordance with examples as disclosed herein. In some implementations, aspects of the operations of 1210 may be performed by an ELR portion component 930 as described with reference to FIG. 9.

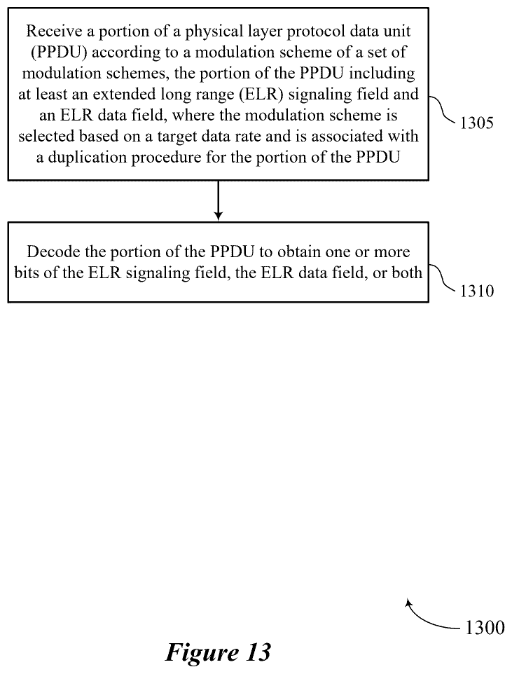

FIG. 13 shows a flowchart illustrating an example process 1300 performable by or at a second wireless device that supports enhanced long range physical layer protocol data unit design and numerology. The operations of the process 1300 may be implemented by a second wireless device or its components as described herein. For example, the process 1300 may be performed by a wireless communication device, such as the wireless communication device 900 described with reference to FIG. 9, operating as or within a wireless AP or a wireless STA. In some implementations, the process 1300 may be performed by a wireless AP or a wireless STA, such as one of the APs 102 or the STAs 104 described with reference to FIG. 1.

In some implementations, in 1305, the second wireless device may receive a portion of a PPDU according to a modulation scheme of a set of modulation schemes, the portion of the PPDU including at least an enhanced long range ELR signaling field and an ELR data field, where the modulation scheme is selected based on a target data rate and is associated with a duplication procedure for the portion of the PPDU. The operations of 1305 may be performed in accordance with examples as disclosed herein. In some implementations, aspects of the operations of 1305 may be performed by an ELR portion manager 940 as described with reference to FIG. 9.

In some implementations, in 1310, the second wireless device may decode the portion of the PPDU to obtain one or more bits of the ELR signaling field, the ELR data field, or both. The operations of 1310 may be performed in accordance with examples as disclosed herein. In some implementations, aspects of the operations of 1310 may be performed by a decoder manager 950 as described with reference to FIG. 9.

### IMPLEMENTATION EXAMPLES ARE DESCRIBED IN THE FOLLOWING NUMBERED CLAUSES

Clause 1: A method for wireless communications at a first wireless device, including: transmitting a first portion of a preamble of a PPDU, the first portion of the preamble including at least a legacy short training field, a legacy long training field, a legacy signal field, and a repeat legacy signal field; and transmitting a second portion of the preamble, the second portion of the preamble including at least a first ELR mark field, a second ELR mark field, and an ELR modulated portion, the first ELR mark field and the second ELR mark field both modulated according to a quadrature-binary phase-shift keying modulation scheme.

Clause 2: The method of clause 1, where transmitting the second portion of the preamble further includes: transmitting the second portion of the preamble that includes an ELR signaling field and an ELR data field.

Clause 3: The method of clause 2, where transmitting the second portion of the preamble further includes: transmitting the second portion of the preamble that includes an ELR short training field and an ELR long training field.

Clause 4: The method of clause 3, where the ELR signaling field includes a version identifier, uplink information, downlink information, a basic service set coloring, an indication of a length or a quantity of symbols, a wireless device identifier, one or more low density parity check or binary convolution code bits, an indication of a modulation and coding scheme, cyclic redundancy check information, one or more tail bits, or any combination thereof.

Clause 5: The method of any of clauses 1-4, further including: modulating the first ELR mark field and the second ELR mark field such that each first tone of a set of first tones is interposed between a respective pair of second tones of a set of second tones, and such that each first tone is populated.

Clause 6: The method of any of clauses 1-5, where transmitting the second portion of the preamble further includes: transmitting the second portion of the preamble that includes an ELR mark sequence that includes at least the first ELR mark field, the second ELR mark field, or both, where the ELR mark sequence includes an indication that identifies an ELR packet.

Clause 7: The method of any of clauses 1-6, where transmitting the second portion of the preamble further includes: transmitting the second portion of the preamble that includes an ELR mark sequence that includes at least the first ELR mark field, the second ELR mark field, or both, where the ELR mark sequence indicates a basic service set coloring, a basic service set identifier, or both.

Clause 8: The method of any of clauses 1-7, where transmitting the second portion of the preamble further includes: transmitting the second portion of the preamble that includes an ELR mark sequence that includes at least the first ELR mark field, the second ELR mark field, or both, where the ELR mark sequence indicates a polarity associated with a power saving procedure for the first wireless device.

Clause 9: A method for wireless communications at a second wireless device, including: receiving a first portion of a preamble of a PPDU, the first portion of the preamble including at least a legacy short training field, a legacy long training field, a legacy signal field, and a repeat legacy signal field; and receiving a second portion of the preamble, the second portion of the preamble including at least a first ELR mark field, a second ELR mark field, and an ELR modulated portion, the first ELR mark field and the second ELR mark field both modulated according to a quadrature-binary phase-shift keying modulation scheme.

Clause 10: The method of clause 9, where receiving the second portion of the preamble further includes: receiving the second portion of the preamble that includes an ELR signaling field and an ELR data field.

Clause 11: The method of clause 10, where receiving the second portion of the preamble further includes: receiving the second portion of the preamble that includes an ELR short training field and an ELR long training field.

Clause 12: The method of clause 11, where the ELR signaling field includes a version identifier, uplink information, downlink information, a basic service set coloring, an indication of a length or a quantity of symbols, a wireless device identifier, one or more low density parity check or binary convolution code bits, an indication of a modulation and coding scheme, cyclic redundancy check information, one or more tail bits, or any combination thereof.

Clause 13: The method of any of clauses 9-12, where the first ELR mark field and the second ELR mark field are modulated such that each first tone of a set of first tones is interposed between a respective pair of second tones of a set of second tones, and such that each first tone is populated.

Clause 14: The method of any of clauses 9-13, where receiving the second portion of the preamble further includes: receiving the second portion of the preamble that includes an ELR mark sequence that includes at least the first ELR mark field, the second ELR mark field, or both, where the ELR mark sequence includes an indication that identifies an ELR packet.

Clause 15: The method of any of clauses 9-14, where receiving the second portion of the preamble further includes: receiving the second portion of the preamble that includes an ELR mark sequence that includes at least the first ELR mark field, the second ELR mark field, or both, where the ELR mark sequence indicates a basic service set coloring, a basic service set identifier, or both.

Clause 16: The method of any of clauses 9-15, where receiving the second portion of the preamble further includes: receiving, from a first wireless device, the second portion of the preamble that includes an ELR mark sequence that includes at least the first ELR mark field, the second ELR mark field, or both, where the ELR mark sequence indicates a polarity associated with a power saving procedure for the first wireless device.

Clause 17: A method for wireless communications at a first wireless device, including: modulating a portion of a PPDU according to a modulation scheme of a set of modulation schemes, the portion of the PPDU including at least an ELR signaling field and an ELR data field, where the modulation scheme is selected based at least in part on a target data rate and is associated with a duplication procedure for the portion of the PPDU; and transmitting the portion of the PPDU in accordance with the modulation scheme.

Clause 18: The method of clause 17, where modulating the portion of the PPDU further includes: modulating the portion of the PPDU according to the modulation scheme in accordance with a time domain duplication procedure, where each repetition of a set of repetitions corresponding to the portion of the PPDU is associated with a respective guard interval.

Clause 19: The method of clause 18, where a first subset of the set of repetitions is interleaved based at least in part on one or more interleaving parameters, and a second subset of the set of repetitions is not interleaved.

Clause 20: The method of any of clauses 17-19, where modulating the portion of the PPDU further includes: modulating the portion of the PPDU according to the modulation scheme in accordance with a time domain duplication procedure, where each repetition of a set of repetitions corresponding to the portion of the PPDU is associated with a same guard interval.

Clause 21: The method of any of clauses 17-20, where modulating the portion of the PPDU further includes: modulating the portion of the PPDU according to the modulation scheme in accordance with a time domain duplication procedure, where each block of a set of blocks corresponding to the portion of the PPDU is associated with a respective guard interval, and where each repetition of a set of repetitions within each block is associated with a same guard interval.

Clause 22: The method of any of clauses 17-21, where modulating the portion of the PPDU further includes: modulating the portion of the PPDU according to the modulation scheme in accordance with a time domain duplication procedure, where each repetition of a set of repetitions is associated with a same pilot mapping and a same polarity.

Clause 23: The method of any of clauses 17-22, where modulating the portion of the PPDU further includes: modulating the portion of the PPDU according to the modulation scheme in accordance with a coded-bits duplication procedure that includes a repetition of one or more blocks before an interleaving procedure.

Clause 24: The method of clause 23, where a block size of the one or more blocks is based at least in part on the target data rate, a quantity of repetitions of the one or more blocks, one or more coding schemes, a resource unit size, or any combination thereof.

Clause 25: The method of any of clauses 17-24, where modulating the portion of the PPDU further includes: modulating the portion of the PPDU according to the modulation scheme in accordance with a frequency domain duplication procedure.

Clause 26: The method of any of clauses 17-25, where modulating the portion of the PPDU further includes: modulating the portion of the PPDU according to the modulation scheme in accordance with a distributed tone resource unit procedure.

Clause 27: A method for wireless communications at a second wireless device, including: receiving a portion of a PPDU according to a modulation scheme of a set of modulation schemes, the portion of the PPDU including at least an ELR signaling field and an ELR data field, where the modulation scheme is selected based at least in part on a target data rate and is associated with a duplication procedure for the portion of the PPDU; and decoding the portion of the PPDU to obtain one or more bits of the ELR signaling field, the ELR data field, or both.

Clause 28: The method of clause 27, where receiving the portion of the PPDU further includes: receiving the portion of the PPDU according to the modulation scheme in accordance with a time domain duplication procedure, where each repetition of a set of repetitions corresponding to the portion of the PPDU is associated with a respective guard interval.

Clause 29: The method of clause 28, where a first subset of the set of repetitions is interleaved based at least in part on one or more interleaving parameters, and a second subset of the set of repetitions is not interleaved.

Clause 30: The method of any of clauses 27-29, where receiving the portion of the PPDU further includes: receiving the portion of the PPDU according to the modulation scheme in accordance with a time domain duplication procedure, where each repetition of a set of repetitions corresponding to the portion of the PPDU is associated with a same guard interval.

Clause 31: The method of any of clauses 27-30, where modulating the portion of the PPDU further includes: modulating the portion of the PPDU according to the modulation scheme in accordance with a time domain duplication procedure, where each block of a set of blocks corresponding to the portion of the PPDU is associated with a respective guard interval, and where each repetition of a set of repetitions within each block is associated with a same guard interval.

Clause 32: The method of any of clauses 27-31, where modulating the portion of the PPDU further includes: modulating the portion of the PPDU according to the modulation scheme in accordance with a time domain duplication procedure, where each repetition of a set of repetitions is associated with a same pilot mapping and a same polarity.

Clause 33: The method of any of clauses 27-32, where receiving the portion of the PPDU further includes: receiving the portion of the PPDU according to the modulation scheme in accordance with a coded-bits duplication procedure that includes a repetition of one or more blocks before an interleaving procedure.

Clause 34: The method of clause 33, where a block size of the one or more blocks is based at least in part on the target data rate, a quantity of repetitions of the one or more blocks, one or more coding schemes, a resource unit size, or any combination thereof.

Clause 35: The method of any of clauses 27-34, where receiving the portion of the PPDU further includes: receiving the portion of the PPDU according to the modulation scheme in accordance with a frequency domain duplication procedure.

Clause 36: The method of any of clauses 27-35, where receiving the portion of the PPDU further includes: receiving the portion of the PPDU according to the modulation scheme in accordance with a distributed tone resource unit procedure.

Clause 37: A first wireless device for wireless communications, including one or more memories storing processor-executable code, and one or more processors coupled with the one or more memories and individually or collectively operable to execute the code to cause the first wireless device to perform a method of any of clauses 1-8.

Clause 38: A first wireless device for wireless communications, including at least one means for performing a method of any of clauses 1-8.

Clause 39: A non-transitory computer-readable medium storing code for wireless communications, the code including instructions executable by one or more processors to perform a method of any of clauses 1-8.

Clause 40: A second wireless device for wireless communications, including one or more memories storing processor-executable code, and one or more processors coupled with the one or more memories and individually or collectively operable to execute the code to cause the second wireless device to perform a method of any of clauses 9-16.

Clause 41: A second wireless device for wireless communications, including at least one means for performing a method of any of clauses 9-16.

Clause 42: A non-transitory computer-readable medium storing code for wireless communications, the code including instructions executable by one or more processors to perform a method of any of clauses 9-16.

Clause 43: A first wireless device for wireless communications, including one or more memories storing processor-executable code, and one or more processors coupled with the one or more memories and individually or collectively operable to execute the code to cause the first wireless device to perform a method of any of clauses 17-26.

Clause 44: A first wireless device for wireless communications, including at least one means for performing a method of any of clauses 17-26.

Clause 45: A non-transitory computer-readable medium storing code for wireless communications, the code including instructions executable by one or more processors to perform a method of any of clauses 17-26.

Clause 46: A second wireless device for wireless communications, including one or more memories storing processor-executable code, and one or more processors coupled with the one or more memories and individually or collectively operable to execute the code to cause the second wireless device to perform a method of any of clauses 27-36.

Clause 47: A second wireless device for wireless communications, including at least one means for performing a method of any of clauses 27-36.

Clause 48: A non-transitory computer-readable medium storing code for wireless communications, the code including instructions executable by one or more processors to perform a method of any of clauses 27-36.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
transmit a first portion of a preamble of a physical layer protocol data unit (PPDU), the first portion of the preamble comprising at least a legacy short training field, a legacy long training field, a legacy signal field, and a repeat legacy signal field; and
transmit a second portion of the preamble, the second portion of the preamble including at least an enhanced long range (ELR) mark field and an ELR modulated portion.

2. The first wireless device of claim 1, wherein, to transmit the second portion of the preamble, the processing system is further configured to cause the first wireless device to:
transmit the second portion of the preamble that includes an ELR signaling field and an ELR data field.

3. The first wireless device of claim 2, wherein, to transmit the second portion of the preamble, the processing system is further configured to cause the first wireless device to:
transmit the second portion of the preamble that includes an ELR short training field and an ELR long training field.

4. The first wireless device of claim 3, wherein the ELR signaling field includes a version identifier, uplink information, downlink information, a basic service set coloring, an indication of a length or a quantity of symbols, a wireless device identifier, one or more low density parity check or binary convolution code bits, an indication of a modulation and coding scheme, cyclic redundancy check information, one or more tail bits, or any combination thereof.

5. The first wireless device of claim 1, wherein, to transmit the second portion of the preamble, the processing system is further configured to cause the first wireless device to:
transmit the second portion of the preamble that includes, in the ELR mark field, an ELR mark sequence that is carried by at least a first ELR mark symbol, a second ELR mark symbol, or both, wherein the ELR mark sequence includes an indication that identifies an ELR packet.

6. The first wireless device of claim 5, wherein the ELR mark sequence indicates a basic service set coloring, a basic service set identifier, or both.

7. The first wireless device of claim 5, wherein the first ELR mark symbol and the second ELR mark symbol are both modulated according to a quadrature-binary phase-shift keying modulation scheme.

8. The first wireless device of claim 1, wherein the preamble comprises an orthogonal frequency-division multiplexing (OFDM)-based, 64-tone preamble that is based at least in part on a 64-point fast Fourier transform, and wherein the ELR mark field is OFDM-based.

9. The first wireless device of claim 1, wherein the ELR modulated portion includes one or more 52-tone resource units, and wherein the ELR modulated portion is based at least in part on a four-repetition duplication procedure.

10. A second wireless device, comprising:
a processing system that includes processor circuitry and memory circuitry that stores code, the processing system configured to cause the second wireless device to:
receive a first portion of a preamble of a physical layer protocol data unit (PPDU), the first portion of the preamble comprising at least a legacy short training field, a legacy long training field, a legacy signal field, and a repeat legacy signal field; and
receive a second portion of the preamble, the second portion of the preamble including at least an enhanced long range (ELR) mark field and an ELR modulated portion.

11. The second wireless device of claim 10, wherein, to receive the second portion of the preamble, the processing system is further configured to cause the second wireless device to:
receive the second portion of the preamble that includes an ELR signaling field and an ELR data field.

12. The second wireless device of claim 11, wherein, to receive the second portion of the preamble, the processing system is further configured to cause the second wireless device to:
receive the second portion of the preamble that includes an ELR short training field and an ELR long training field.

13. The second wireless device of claim 12, wherein the ELR signaling field includes a version identifier, uplink information, downlink information, a basic service set coloring, an indication of a length or a quantity of symbols, a wireless device identifier, one or more low density parity check or binary convolution code bits, an indication of a modulation and coding scheme, cyclic redundancy check information, one or more tail bits, or any combination thereof.

14. The second wireless device of claim 10, wherein, to receive the second portion of the preamble, the processing system is further configured to cause the second wireless device to:
receive the second portion of the preamble that includes, in the ELR mark field an ELR mark sequence that is carried by at least a first ELR mark symbol, a second ELR mark symbol, or both, wherein the ELR mark sequence includes an indication that identifies an ELR packet.

15. The second wireless device of claim 14, wherein the ELR mark sequence indicates a basic service set coloring, a basic service set identifier, or both.

16. The second wireless device of claim 14, wherein the first ELR mark symbol and the second ELR mark symbol are both modulated according to a quadrature-binary phase-shift keying modulation scheme.

17. The second wireless device of claim 10, wherein the preamble comprises an orthogonal frequency-division multiplexing (OFDM)-based, 64-tone preamble, and wherein the ELR mark field is OFDM-based.

18. The second wireless device of claim 10, wherein the ELR modulated portion includes one or more 52-tone resource units, and wherein the ELR modulated portion is based at least in part on a four-repetition duplication procedure.

19. A first wireless device, comprising:
a processing system that includes processor circuitry and memory circuitry that stores code, the processing system configured to cause the first wireless device to:
modulate a portion of a physical layer protocol data unit (PPDU) according to a modulation scheme of a set of modulation schemes, the portion of the PPDU including at least an enhanced long range (ELR) signaling field and an ELR data field, wherein the modulation scheme is selected based at least in part on a target data rate and is associated with a duplication procedure for the portion of the PPDU; and
transmit the portion of the PPDU in accordance with the modulation scheme.

20. The first wireless device of claim 19, wherein, to modulate the portion of the PPDU, the processing system is further configured to cause the first wireless device to:
modulate the portion of the PPDU according to the modulation scheme in accordance with a frequency domain duplication procedure.

21. The first wireless device of claim 19, wherein, to modulate the portion of the PPDU, the processing system is further configured to cause the first wireless device to:
modulate the portion of the PPDU according to the modulation scheme in accordance with a time domain duplication procedure, wherein each repetition of a set of repetitions corresponding to the portion of the PPDU is associated with a respective guard interval.

22. The first wireless device of claim 21, wherein:
a first subset of the set of repetitions is interleaved based at least in part on one or more interleaving parameters, and
a second subset of the set of repetitions is not interleaved.

23. The first wireless device of claim 19, wherein, to modulate the portion of the PPDU, the processing system is further configured to cause the first wireless device to:
modulate the portion of the PPDU according to the modulation scheme in accordance with a time domain duplication procedure, wherein each repetition of a set of repetitions corresponding to the portion of the PPDU is associated with a same guard interval.

24. The first wireless device of claim 19, wherein, to modulate the portion of the PPDU, the processing system is further configured to cause the first wireless device to:
modulate the portion of the PPDU according to the modulation scheme in accordance with a time domain duplication procedure, wherein each block of a set of blocks corresponding to the portion of the PPDU is associated with a respective guard interval, and wherein each repetition of a set of repetitions within each block is associated with a same guard interval.

25. A second wireless device, comprising:
a processing system that includes processor circuitry and memory circuitry that stores code, the processing system configured to cause the second wireless device to:
receive a portion of a physical layer protocol data unit (PPDU) according to a modulation scheme of a set of modulation schemes, the portion of the PPDU including at least an enhanced long range (ELR) signaling field and an ELR data field, wherein the modulation scheme is selected based at least in part on a target data rate and is associated with a duplication procedure for the portion of the PPDU; and
decode the portion of the PPDU to obtain one or more bits of the ELR signaling field, the ELR data field, or both.

26. The second wireless device of claim 25, wherein, to receive the portion of the PPDU, the processing system is further configured to cause the second wireless device to:
receive the portion of the PPDU according to the modulation scheme in accordance with a frequency domain duplication procedure.

27. The second wireless device of claim 25, wherein, to receive the portion of the PPDU, the processing system is further configured to cause the second wireless device to:
receive the portion of the PPDU according to the modulation scheme in accordance with a time domain duplication procedure, wherein each repetition of a set of repetitions corresponding to the portion of the PPDU is associated with a respective guard interval.

28. The second wireless device of claim 27, wherein:
a first subset of the set of repetitions is interleaved based at least in part on one or more interleaving parameters, and
a second subset of the set of repetitions is not interleaved.

29. The second wireless device of claim 25, wherein, to receive the portion of the PPDU, the processing system is further configured to cause the second wireless device to:
receive the portion of the PPDU according to the modulation scheme in accordance with a time domain duplication procedure, wherein each repetition of a set of repetitions corresponding to the portion of the PPDU is associated with a same guard interval.

30. The second wireless device of claim 25, wherein, to receive the portion of the PPDU, the processing system is further configured to cause the second wireless device to:
receive the portion of the PPDU according to the modulation scheme in accordance with a time domain duplication procedure, wherein each block of a set of blocks corresponding to the portion of the PPDU is associated with a respective guard interval, and wherein each repetition of a set of repetitions within each block is associated with a same guard interval.
